(19) United States
(12) Patent Application Publication
(10) Pub. No.: US 2014/0252189 A1
(43) Pub. Date: Sep. 11, 2014

(54) ADJUSTMENT ASSEMBLY FOR USE IN AUDIO/VISUAL MOUNTING SYSTEMS OR THE LIKE

(71) Applicant: PEERLESS INDUSTRIES, INC., Aurora, IL (US)

(72) Inventors: Jason Alan Kifer, Aurora, IL (US); Ruben Dario Badillo, Shorewood, IL (US)

(73) Assignee: PEERLESS INDUSTRIES, INC., Aurora, IL (US)

(21) Appl. No.: 13/785,901

(22) Filed: Mar. 5, 2013

(51) Int. Cl. F16M 13/02

(52) U.S. Cl. CPC F16M 13/022
USPC 248/299.1

(57) ABSTRACT

A device mount for supporting an audio/visual device may include a first mounting portion configured to couple to the audio/visual device, a second mounting portion configured to couple to the first mounting portion and to a mounting member, a puck disposed between the first mounting portion and the second mounting portion, and a coupling member. The first mounting portion includes a curved portion having a slot. The second mounting portion includes a first opening. The puck includes a curved inner surface that complements the curved portion of the first mounting portion and a second opening. The coupling member is configured to insert, at least partially, through the slot, the first opening, and the second opening to couple the first mounting portion, the puck, and the second mounting portion. The first mounting portion is pivotable and/or rotatable relative to the second mounting portion.

### BACKGROUND

The present application relates generally to the field of mounts for mounting and displaying attached devices. More specifically, the present application relates to moveable device mounts for mounting and displaying attached audio/visual devices.

### SUMMARY

One embodiment relates to a mounting system for supporting an audio/visual device. The mounting system may include a first mounting portion configured to couple to the audio/visual device, a second mounting portion configured to couple to the first mounting portion and to a mounting member, a puck disposed between the first mounting portion and the second mounting portion, and a coupling member. The first mounting portion may include a curved portion having a slot. The second mounting portion may include a first opening. The puck may include a curved inner surface that complements the curved portion of the first mounting portion and a second opening. The coupling member may be configured to insert, at least partially, through the slot, the first opening, and the second opening to couple the first mounting portion, the puck, and the second mounting portion. The first mounting portion may be pivotable relative to the second mounting portion.

Another embodiment relates to a device mount. The device mount may include a first mounting portion configured to operatively connect to a device. The first mounting portion may include a variable attachment opening and a curved portion having an outer surface and a slot formed through the curved portion. The device mount may also include a second mounting portion configured to couple to a mounting surface and having a first opening. The device mount may further include a puck disposed between the first mounting portion and the second mounting portion. The puck may include a second opening and a curved inner surface that complements the outer surface of the curved portion of the first mounting portion. The device mount may include a retaining member and a coupling member. The coupling member may be configured to insert through the slot, the first opening, and the second opening, and couple to the retaining member such that the coupling member and the retaining member cooperatively couple together the first mounting portion, the puck, and the second mounting portion. The first mounting portion may be pivotable relative to the second mounting portion.

Yet another embodiment relates to another device mount. The device mount may include a first mounting portion having a first curved portion and a second curved portion. The first curved portion may include a first outer surface and the second curved portion may include a second outer surface. The first curved portion may include a first slot formed through the first curved portion and the second curved portion may include a second slot formed through the second curved portion. The device mount may also include a second mounting portion configured to couple to a mounting surface and having a first opening and a curved slot. The device mount may further include a first puck and a second puck disposed between the first mounting portion and the second mounting portion. The first puck may include a second opening and a first curved inner surface that complements the first outer surface of the first curved portion of the first mounting portion. The second puck may include a third opening and a second curved inner surface that complements the second outer surface of the second curved portion of the first mounting portion. The device mount may include a first and a second retaining member and a first and a second coupling member. The first coupling member may be configured to insert through the first opening, the second opening, and the first slot, and couple to the first retaining member such that the first coupling member and the first retaining member cooperatively couple together the first mounting portion, the first puck, and the second mounting portion. The second coupling member may be configured to insert through the curved slot, the third opening, and the second slot, and couple to the second retaining member such that the second coupling member and the second retaining member cooperatively couple together the first mounting portion, the second puck, and the second mounting portion. The first mounting portion may be pivotable relative to the second mounting portion.

### BRIEF DESCRIPTION OF THE DRAWINGS

FIG. 1 is a perspective view of an exemplary embodiment of a device mount.

FIG. 2 is a front plan view of the device mount of FIG. 1.

FIG. 3 is a rear plan view of the device mount of FIG. 1.

FIG. 4 is a top view of the device mount of FIG. 1.

FIG. 5 is a bottom view of the device mount of FIG. 1.

FIG. 6 is a right side view of the device mount of FIG. 1.

FIG. 7 is a left side view of the device mount of FIG. 1.

FIG. 8 is an exploded perspective view of the device mount of FIG. 1.

FIG. 9 is a sectional side view of the device mount of FIG. 1 taken along line 9-9 of FIG. 2.

FIG. 10 is a perspective view of a device mounting plate of the device mount of FIG. 1.

FIG. 11 is a rear plan view of the device mounting plate of FIG. 10.

FIG. 12 is a top view of the device mounting plate of FIG. 10.

FIG. 13 is a left side view of the device mounting plate of FIG. 10.

FIG. 14 is a perspective view of a puck of the device mount of FIG. 1.

FIG. 15 is a front plan view of the puck of FIG. 14.

FIG. 16 is a rear plan view of the puck of FIG. 14.

FIG. 17 is a top view of the puck of FIG. 14.

FIG. 18 is a bottom view of the puck of FIG. 14.

FIG. 19 is a perspective view of the retaining member of the device mount of FIG. 1.

FIG. 20 is a front plan view of the retaining member of FIG. 19.

FIG. 21 is a rear plan view of the retaining member of FIG. 19.

FIG. 22 is a top view of the retaining member of FIG. 19.

FIG. 23 is a right side view of the retaining member of FIG. 19.

FIG. 24 is a perspective view of an alternative exemplary embodiment of a device mount.

FIG. 25 is a front plan view of the device mount of FIG. 24.

FIG. 26 is a rear plan view of the device mount of FIG. 24.

FIG. 27 is a top view of the device mount of FIG. 24.

FIG. 28 is a left side view of the device mount of FIG. 24.

FIG. 29 is an exploded perspective view of the device mount of FIG. 24.

FIG. 30 is a perspective view of yet another exemplary embodiment of a device mount.

FIG. 31 is a rear plan view of the device mount of FIG. 30.

FIG. 32 is a top view of the device mount of FIG. 30.

FIG. 33 is a left side view of the device mount of FIG. 30.

FIG. 34 is an exploded perspective view of the device mount of FIG. 30.

FIG. 35 is a perspective view of still another exemplary embodiment of a device mount.

FIG. 36 is an exploded perspective view of the device mount of FIG. 35.

FIG. 37 is a front plan view of a device mounting plate of the device mount of FIG. 35.

FIG. 38 is a top view of the device mounting plate of FIG. 37.

FIG. 39 is a left side view of the device mounting plate of FIG. 37.

FIG. 40 is a detail view of the detail A shown in FIG. 37.

FIG. 41 is a perspective view of another exemplary embodiment of a device mount.

FIG. 42 is an exploded perspective view of the device mount of FIG. 41.

FIG. 43 is a perspective view of yet another exemplary embodiment of a device mount.

FIG. 44 is a front plan view of an exemplary embodiment of a device mounting plate having wing plate extensions.

FIG. 45 is an exploded perspective view of the device mounting plate and wing plate extensions of FIG. 44.

FIG. 46 is an exploded perspective view of another exemplary embodiment of a device mounting plate having wing plate extensions.

FIG. 47 is a front plan view of the device mounting plate and wing plate extensions of FIG. 46 according to a first configuration.

FIG. 48 is a front plan view of the device mounting plate and wing plate extensions of FIG. 46 according to a second configuration.

FIG. 49 is a front plan view of the device mounting plate and wing plate extensions of FIG. 46 according to a third configuration.

FIG. 50 is an exploded perspective view of still another exemplary embodiment of a device mounting plate having wing plate extensions.

FIG. 51 is a front plan view of the device mounting plate and wing plate extensions of FIG. 50 according to a first configuration.

FIG. 52 is a front plan view of the device mounting plate and wing plate extensions of FIG. 50 according to a second configuration.

FIG. 53 is a front plan view of the device mounting plate and wing plate extensions of FIG. 50 according to a third configuration.

FIG. 54 is a front plan view of the device mounting plate and wing plate extensions of FIG. 50 according to a third configuration.

### DETAILED DESCRIPTION

With general reference to the Figures, disclosed in the present application are various embodiments of device mounts that are configured to provide support and adjustability to a device, such as a display device (e.g., a flat-screen or panel television). The device mounts include a device mounting plate having one or more mounting openings that permit a device, such as a display device, to be mounted to the device mount without disassembly and/or removal of the device mounting plate from the device mount.

In addition, improved tilt functionality is incorporated into the device mounts via an adjustment assembly that provides for tilt adjustment of the mounted device (e.g., display device) mounted relative to a fixing member or support, such as a wall or free standing member, to which the device mount is attached. The adjustment assembly allows the mounted devices to pivot or tilt to provide tilt adjustment of the mounted device, such as for a customer or user to reposition the display device to improve visibility thereof. In addition, the adjustment assembly allows the mounted devices to roll or rotate in a limited fashion about a central axis to provide roll adjustment of the mounted device, such as for a customer or user to reposition the display device to improve visibility thereof.

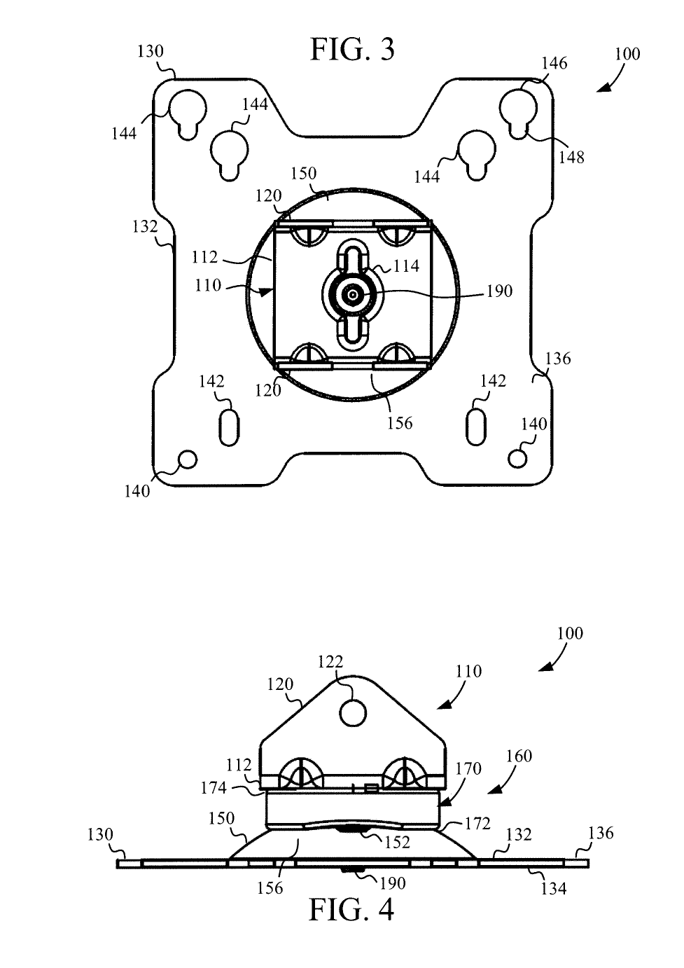

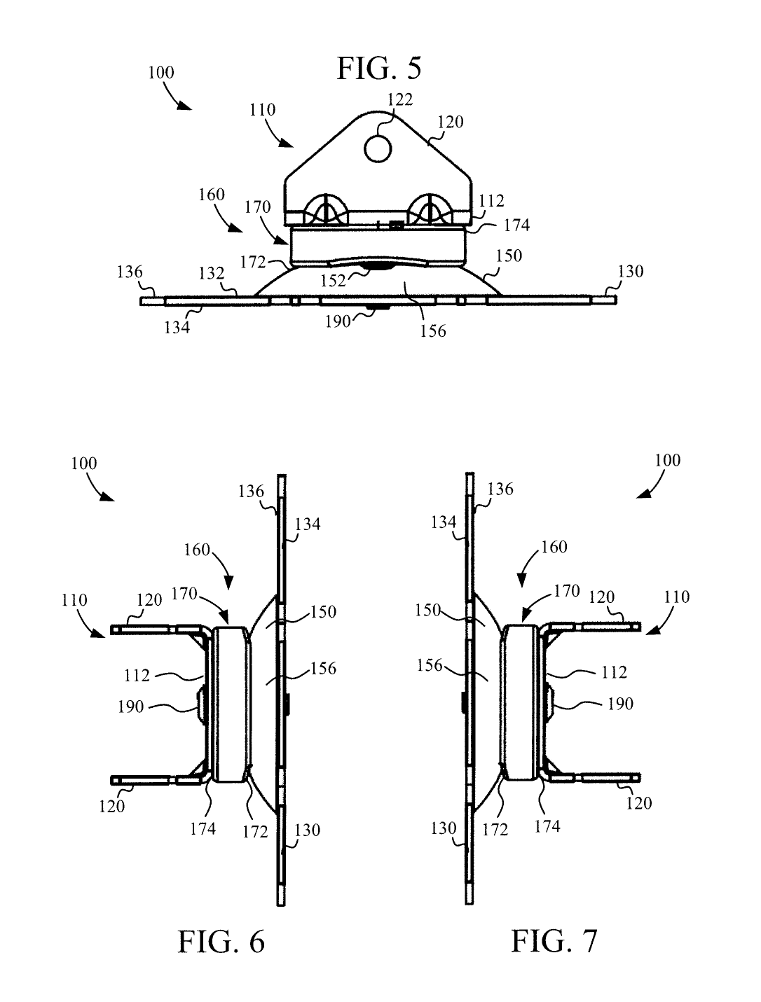

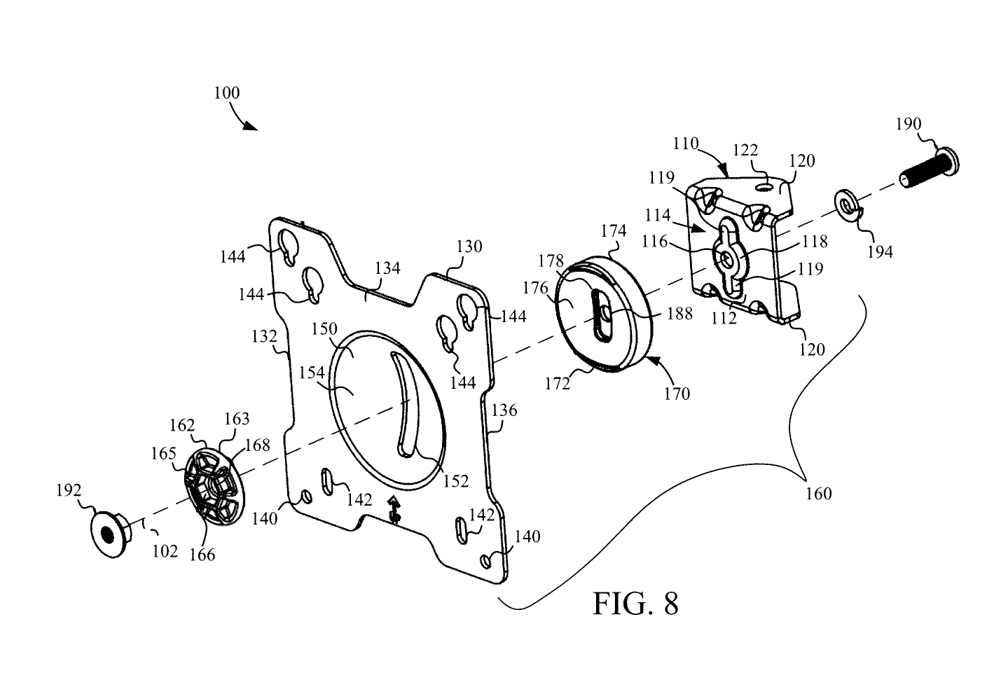

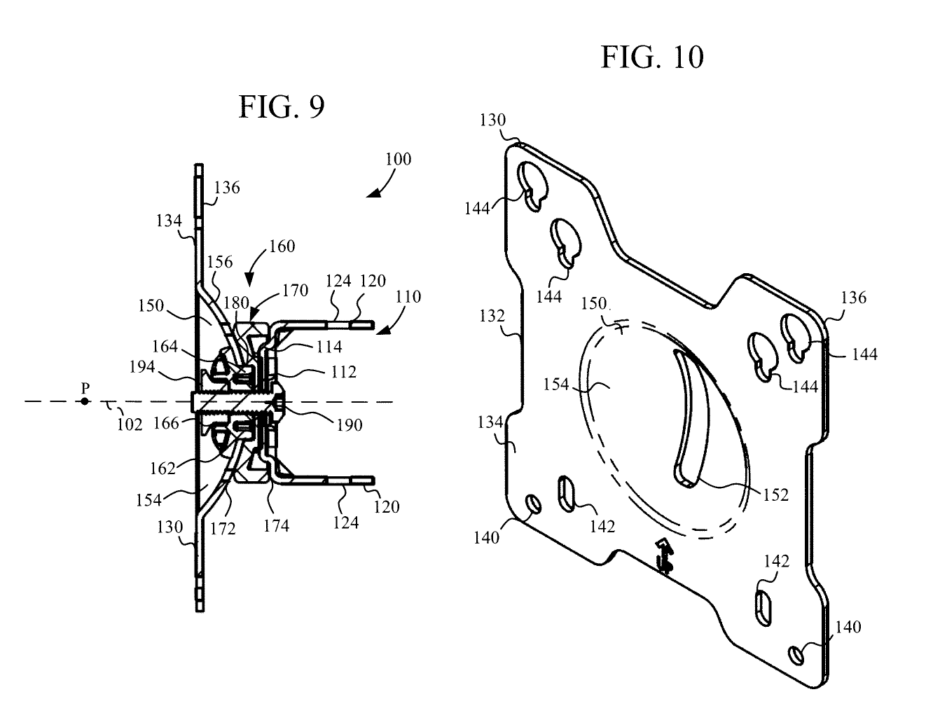

FIGS. 1-9 illustrate an exemplary embodiment of a device mount 100 that is configured to provide for the variable tilt adjustment of a coupled device, such as a flat screen or panel display device, relative to a fixing member or support, such as a wall, free-standing support member, and/or other member capable of supporting the combined weight of the device mount 100 and the coupled device. As shown in FIG. 1, the device mount 100 includes a mounting bracket 110, a device mounting plate 130, and an adjustment assembly 160. The mounting bracket 110 couples the device mount 100 to a support member, such as a wall, free-standing support, or other member. The adjustment assembly 160 couples the mounting bracket 110 to the device mounting plate 130, such that the adjustment assembly 160 allows for variable tilting of a mounted device coupled to the device mounting plate 130 relative to the mounting bracket 110. The device mount 100 is configured to permit an attached device to move about a point P (shown in FIGS. 1 and 9). In addition, the components of the device mount 100 are coupled together by a coupling member 190 (e.g., a bolt in particular embodiments) defining a central axis 102 for the device mount 100.

The mounting bracket 110 (e.g., the second mounting portion) of the present example is configured to couple, affix, and/or otherwise attach the device mount 100 to a fixing member, such as a support member, free-standing support, etc. The mounting bracket 110 shown in FIGS. 1-9 comprises a base portion 112 and a pair of attachment members 120 extending substantially perpendicular from the base portion 112. In some implementations, the attachment members 120 may extend from angles other than perpendicular, such as oblique angles. For example, the attachment members 120 may extend from the base portion 112 at an angle of 180 degrees, thereby forming a substantially flat plate for mounting bracket 110. Of course other angles for the attachment members 120 may be used as well, such as any angle from greater than 0 degrees to 180 degrees, inclusive.

The attachment members 120 each include an opening 122 and/or or any suitable feature for coupling such that the attachment members 120 may be coupled to a fixing member and/or otherwise affixed, pinned, etc. to a fixing member by a fastener (e.g., a bolt, pin, etc.). By way of example only, a pin (not shown) may be inserted through openings 122 of attachment members 120 to couple the mounting bracket 110 to a support member (also not shown). In some implementations, the pin, fixing member, and mounting bracket 110 may form a pivotable joint that pivots about an axis defined by openings 122. Of course, in some instances, the attachment members 120 may be affixed or otherwise attached to a fixing member such that the mounting bracket 110 may not be pivotable or otherwise movable relative to the support member. For example, the attachment members 120 may be bolted, welded, and/or otherwise affixed to a fixing member.

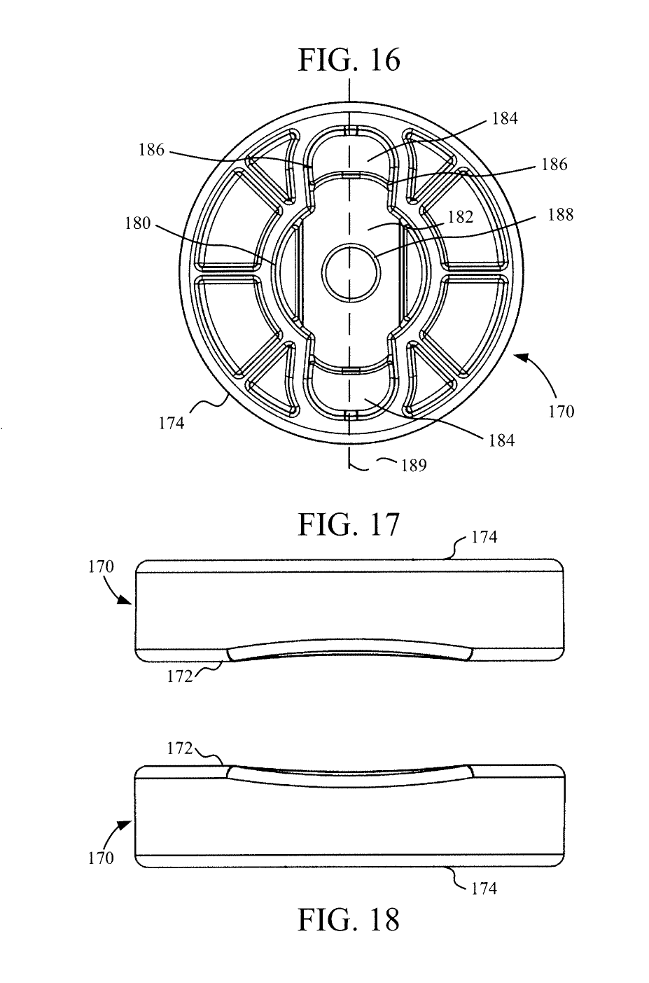

The base portion 112 of the mounting bracket 110 is configured to couple to the adjustment assembly 160 via the coupling member 190 extending through an opening 116 formed in the base portion 112 and defined by central axis 102. In the present example, the base portion 112 includes a protrusion 114 (shown best in FIG. 8) formed on a surface of the base portion 112 opposite to the attachment members 120. In some instances, the protrusion 114 may have a geometric configuration such that limited rotation of the protrusion 114 relative to a puck 170 of the adjustment assembly 160 is permitted via a recessed portion 180 (shown best in FIG. 16) formed in the puck 170, as will be described in greater detail below. The protrusion 114 of the present example includes a central cylindrical protrusion 118 defined by a central axis corresponding to the central axis 102 and a pair of opposing protrusions 119 extending longitudinally in opposite directions from the central cylindrical protrusion 118. Of course, the protrusion 114 may have other geometric configurations to substantially moveably couple to the puck 170, such as a longitudinal protrusion extending along the base portion 112 without the central cylindrical protrusion 118, triangular protrusion, a quadrilateral protrusion, a pentagonal protrusion, a hexagonal protrusion, a star protrusion, etc.

When the protrusion 114 of the base portion 112 is inserted into and coupled to the recessed portion 180 of the puck 170 of the adjustment assembly 160, the mounting bracket 110 is permitted to move relative to the puck 170 a predetermined amount, such as ±5 degrees, about the central axis 102, as will be discussed in greater detail below. The base portion 112 and the protrusion 114 further includes an opening 116 defined by central axis 102, which may be configured to receive another component, such as the coupling member 190, to couple the mounting bracket 110 to the adjustment assembly 160 while still permitting tilt of the mounting bracket relative to the device mounting plate 130.

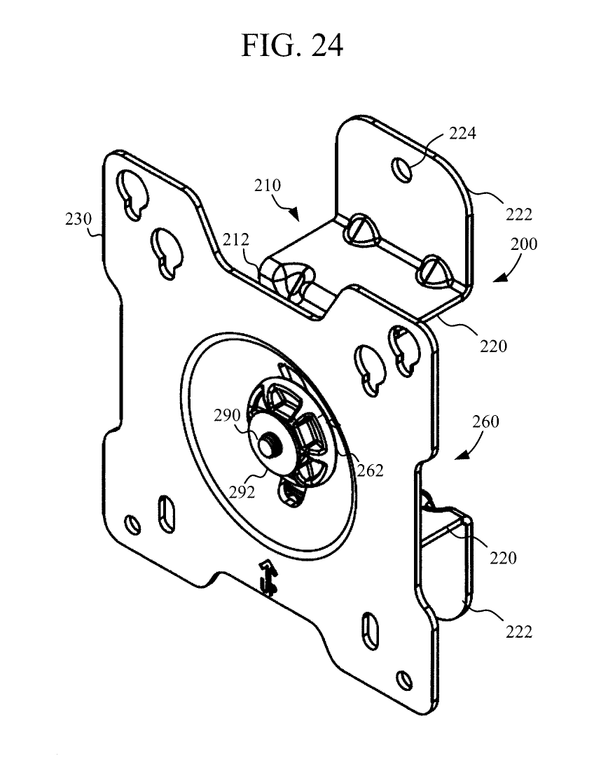

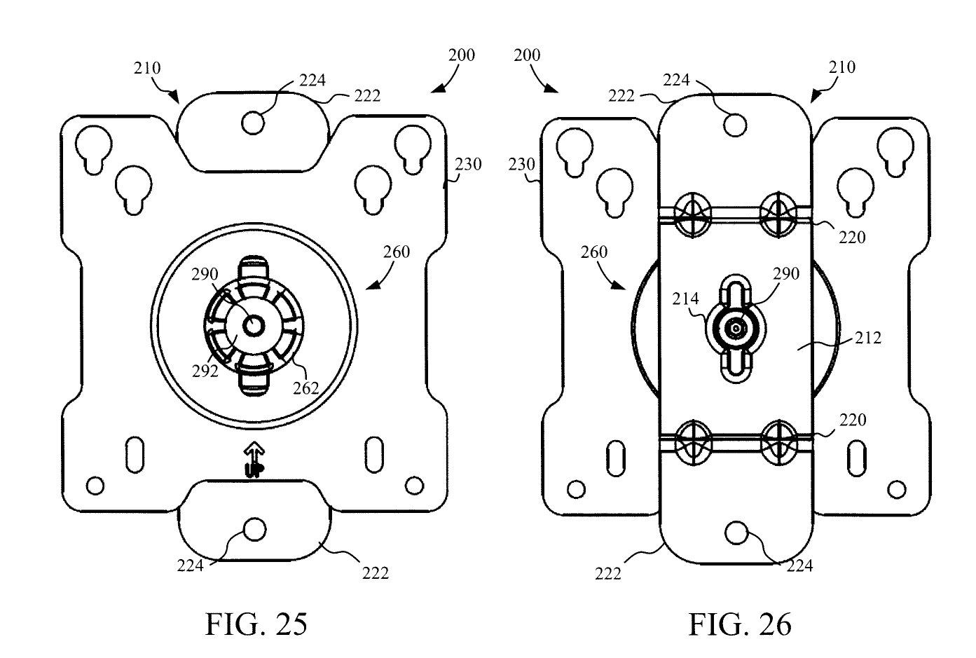

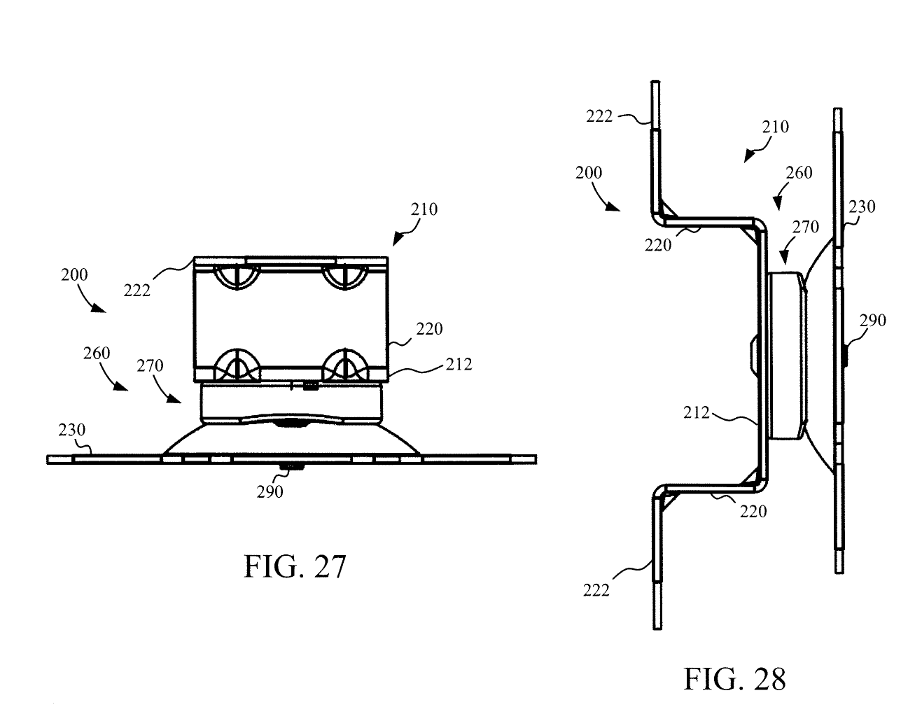

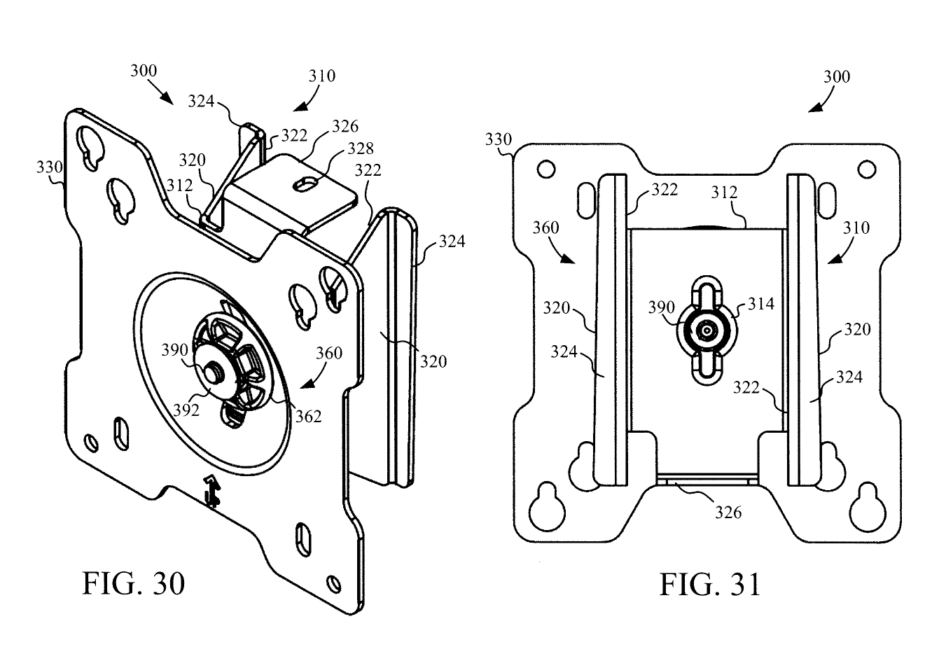

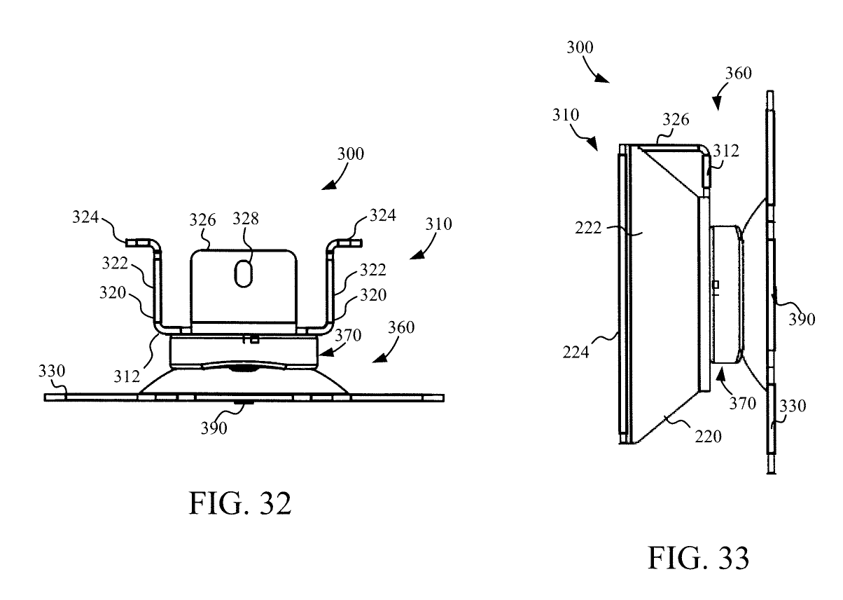

Although FIGS. 1-9 shows the mounting bracket 110 adapted for coupling the device mount 100 to a fixing member, such as a support member or free-standing member, via attachment members 120, the mounting bracket 110 may be adapted to be coupled to any suitable member, fixture and/or other component. For example, as shown in FIGS. 24-29, an alternative device mount 200 is shown having a mounting bracket 210 configured to affix and/or otherwise couple the device mount 200 to a planar surface, such as a wall, and/or other fixing member. In yet another example, FIGS. 30-34 depict yet another device mount 300 having a slidable mounting member 310 configured to slidably insert into and/or couple to a channel or other member to couple the device mount 300 thereto. Device mounts 200, 300 will be described in greater detail herein.

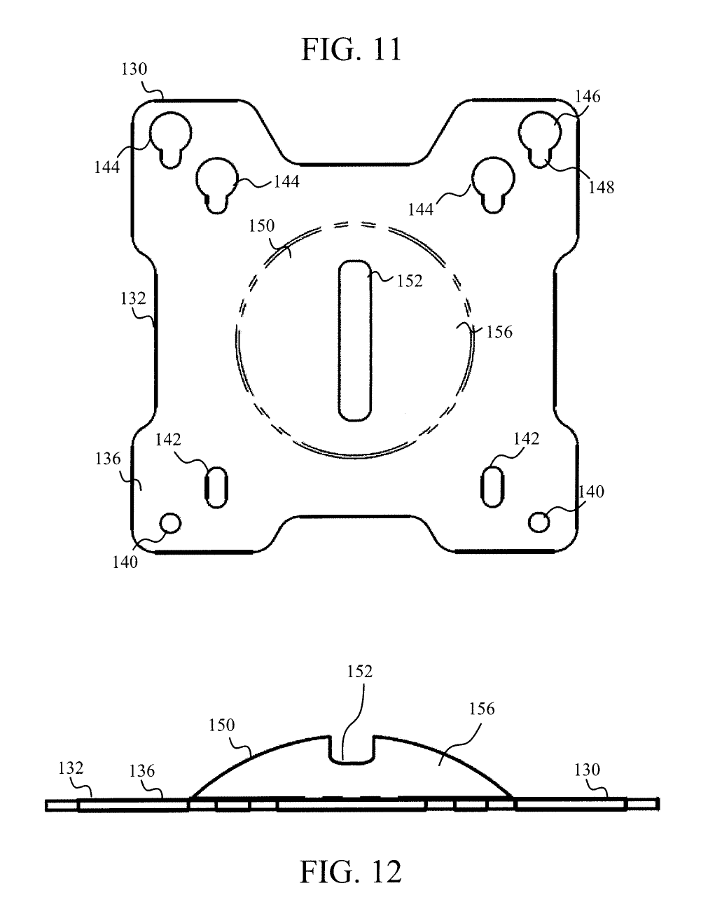

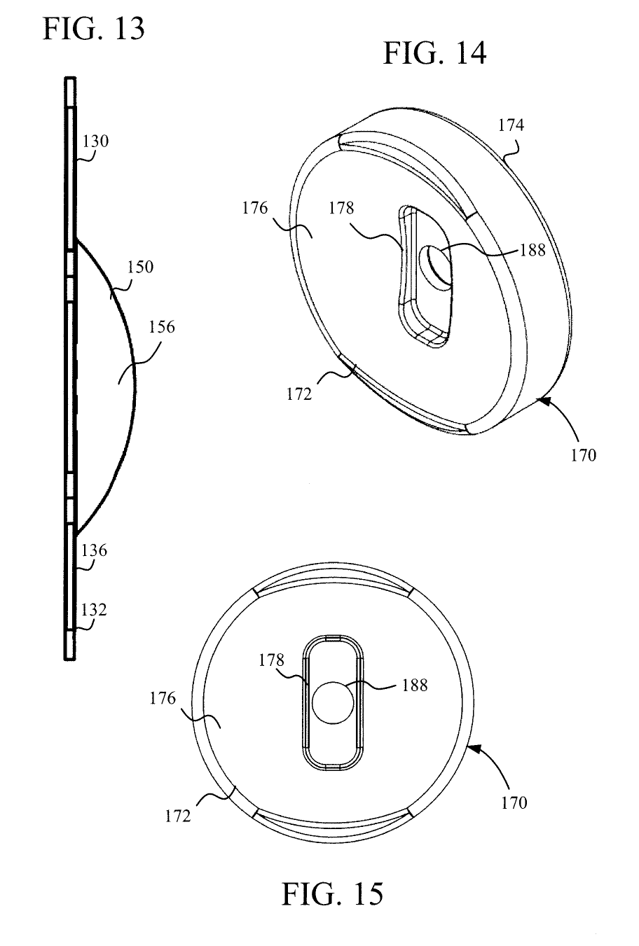

Referring to FIGS. 1-13, the device mounting plate 130 (e.g., the first mounting portion) is adapted to secure a device (e.g., a display device) to the device mount 100. For example, the device mounting plate 130 may be coupled to the adjustment assembly 160 of the device mount 100, whereby the tilt orientation of a secured display device is adjustable relative to the support member (and/or the mounting bracket 110) via the adjustment assembly 160.

The device mounting plate 130 includes a base 132 having a first side 134 and a second side 136 and that is configured to couple to and/or otherwise receive and/or be attached to a device. The device mounting plate 130 may also include forms, flanges, ribs, or other structural members to improve the strength and rigidity of the device mounting plate 130. As shown in FIG. 1, the base 132 of the device mounting plate 130 includes a substantially planar base 132 that may be abutted against a device having one or more attachment points (e.g., bolt openings or other attachment mechanisms). The device mounting plate 130 and/or the base 132 may also include voids or lightening openings to reduce the mass of the device mounting plate 130 and/or the base 132. The mass reduction voids may be varied in size and location, based on the desired mass and/or strength of the device mounting plate 130 and/or the base 132.

In the present example, the base 132 includes a pair of lower attachment openings 140, a pair of lower attachment slots 142, and four variable upper attachment openings 144. The attachment openings 140, attachment slots 142, and/or variable attachment openings 144 may be positioned in base 132 to form a flat display mounting interface (FDMI) or VESA mount. The attachment openings 140, attachment slots 142, and/or variable attachment openings 144 may be positioned to form one or more patterns, such as standard patterns set by the Video Electronics Standards Association (VESA). Exemplary applicable VESA patterns include, for example, 75 millimeters (mm) by 75 millimeters (mm), 100 mm by 100 mm, 200 mm by 100 mm, 100 mm by 200 mm, 200 mm by 200 mm, 300 mm by 300 mm, 400 mm by 400 mm, 400 mm by 200 mm, combinations thereof, and/or any other suitable pattern.

In some implementations, the attachment openings 140, attachment slots 142, and/or variable attachment openings 144 may be sized to receive mounting hardware, such as M4, M5, M6, and/or M8 mounting screws or bolts. In some implementations, as will be described in greater detail in reference to FIG. 40, the attachment openings 140, attachment slots 142, and/or variable attachment openings 144 may be configured to have a common mounting opening pattern such that the attachment openings 140, attachment slots 142, and/or variable attachment openings 144 may be capable of receiving multiple sizes of mounting hardware, thereby permitting the device mounting plate 130 to be coupled using a variety of mounting hardware. Accordingly, the device mounting plate 130 may be usable with a wide variety of devices having varying mounting hardware sizes and/or mounting pattern configurations.

The variable upper attachment openings 144 include an upper portion 146 and a lower portion 148. In the present example the upper portion 146 is sized and configured such that the head of a mounting screw, bolt, and/or other hardware is capable of being passed through the upper portion 146 while the mounting hardware is attached to another object, such as the device to be attached to the device mounting plate 130. The lower portion 148 of the variable upper attachment openings 144 is size to accommodate the body of the one or more mounting hardware components. In some instances, the lower portion 148 of the variable upper attachment openings 144 may increasingly narrow as the lower portion 148 extends away from the upper portion 146. In some instances, the lower portion 148 may continuously decrease to a point, thereby forming an inverted tear-drop shape for the variable upper attachment openings 144, or, in some instances, the lower portion 148 may have discrete steps or tiers, such as that shown in FIG. 40. Accordingly, the lower portion 148 may accommodate various mounting hardware having different body sizes (e.g., M4, M5, M6, and/or M8 mounting hardware). It should be understood that the lower portion 148 may provide both a vertical support surface against which the mounting hardware (and therefore the device) may be supported by the device mounting plate 130 (e.g., to prevent the device from falling due to gravity) and couple the device to the device mounting plate 130 by the providing a horizontal support surface against which the head of the mounting screw or bolt may abut. In some instances, the vertical support surface may be at the bottom of the lower portion 148, such as that shown in FIG. 1, and/or may be at any other point along the lower portion 148, such as where the lower portion 148 narrows continuously in a V-shaped manner and/or in a stepped manner.

The variable upper attachment openings 144 enable a user to mount a device to the device mounting plate 130 without decoupling or detaching the device mounting plate 130 from the remainder of the device mount 100. In addition, the variable upper attachment openings 144 enable a single user to attach a device to the device mounting plate 130 without assistance from another individual. For example, to affix a device to the base 132 of the device mounting plate 130, at least two screws or mounting hardware may initially be coupled to at least two upper attachment points (e.g., screw or bolt openings) of the device on opposing sides of the center of gravity for the device. The user may then align the heads of the mounting screws or other hardware with the upper portions 146 of the variable upper attachment openings 144. The user may then insert the heads of the mounting screws or other hardware through the upper portions 146 such that the device is on the first side 134 of the base 132 and the heads of the mounting screws or other hardware protrudes through to the second side 136. The user may then lower the device until the bodies of the mounting screws or other hardware contact and are substantially supported by the lower portion 148 of the variable upper attachment openings 144.

With the device substantially supported by the at least two upper mounting screws or other hardware, the user may attach one or more additional mounting screws or other hardware to the device through one or more of the lower attachment openings 140 and/or lower attachment slots 142, depending upon how the attachment points of the device align with the lower attachment openings 140 and/or lower attachment slots 142. In some implementations, the user may tighten the mounting screws or other hardware inserted through the lower attachment openings 140 and/or lower attachment slots 142 to a desired torque level (such as that provided by a device manufacturer and/or otherwise). With the lower mounting screws or other hardware affixing the device to the base 132 of the device mounting base 130, the user may tighten the mounting screws or other hardware inserted through the variable upper attachment openings 144 to a desired torque level (such as that provided by a device manufacturer and/or otherwise). Accordingly, the device may be substantially secured to the device mounting plate 130 of the device mount 100. If the device mount 100 is coupled to and/or otherwise affixed to a fixing member, such as a support member, free-standing support, etc., then the device may be substantially supported by the device mount 100 via the device mounting plate 130, through the adjustment assembly 160, to the mounting bracket 110.

Still referring to FIGS. 1-13, the device mounting plate 130 further includes a raised curved portion 150 extending from the second side 136 of the device mounting plate 130 and having an inner surface 154 and a outer surface 156. The curved portion 150 may have substantially the same thickness as the base 132 and forms a substantially homogeneous continuum of material with the base 132. The curved portion 150 further includes a longitudinal slot 152 formed through the curved portion 150 to permit a component, such as the coupling member 190, to extend through the curved portion 150 and permits the component to move about a point, such as point P, while sliding within the longitudinal slot 152.

Referring back to FIGS. 8-9, the adjustment assembly 160 of the present example comprises the curved portion 150 of the device mounting plate 130, a puck 170, the coupling member 190, and a nut 192. In the present example, the adjustment assembly 160 further includes a retaining member 162 and a lock washer 194, though these may be optional in some implementations.

Referring to FIGS. 8 and 14-18, the puck 170 includes a curved inner surface 176 on a first side 172 and a recessed portion 180 on a second side 174. The curved inner surface 176 is configured to substantially complement the curved portion 150 of the device mounting plate 130, as shown best in FIG. 9. The adjustment assembly 160 may be configured to compensate for the weight of the mounted device by allowing the user to adjust the mounted device by applying a similar force in one direction (i.e., applying a force to a first end or second end of the device) and/or applying a similar force in opposing directions (e.g., clockwise, counter-clockwise). For example, one configuration for the adjustment assembly 160 to compensate for the weight of the mounted device may be by tightening the nut 192 to the coupling member 190 with the puck 170 and device mounting plate 130 therebetween. Accordingly, the puck 170 and the device mounting plate 130 may frictionally resist movement based on the compression force applied by the coupling member 190 and nut 192. In some instances, the coupling member 190 and nut 192 may be tightened to a torque of 25 inch-pounds, 35 inch-pounds, 45 inch-pounds, 55 inch-pounds, and/or any other suitable torque. In some implementations, the surface of the curved inner surface 176 and/or the outer surface of the curved portion 150 of the device mounting plate 130 may include ridging, dimpling, or other friction-inducing features to further resist movement by the adjustment assembly 160 until a predetermined force (e.g., torque) is applied to overcome the frictional resistance. In other implementations, the surface of the curved inner surface 176 and/or the outer surface of the curved portion 150 of the device mounting plate 130 may include friction reducing features or materials (e.g., polytetrafluoroethylene, or Teflon®, coating or the like) to reduce the resistance against movement of the adjustment assembly 160. Of course, other configurations for the curved inner surface 176 may be used as well.

In some implementations, such as those using a retaining member 162, the curved inner surface 176 of the puck 170 may further include a longitudinal recess 178 formed in a central portion of the curved inner surface 176 on the first side 172 of the puck 170. As will be described in greater detail below, the longitudinal recess 178 may receive a protrusion 164 of the retaining member 162. The protrusion 164 and longitudinal recess 178 may have a length that may be greater than the width of the longitudinal slot 152 of the curved portion 150 such that, when the protrusion 164 is inserted into the longitudinal recess 178 of the puck 170 through the longitudinal slot 152 and having the curved portion 150 positioned between the puck 170 and the retaining member 162, the retaining member 162 and puck 170 are substantially prevented from rotating via the protrusion 164 being substantially prevented from rotating within the longitudinal slot 152 of the curved portion 150 of the device mounting plate 130. Of course, in some implementations, the protrusion 164 and/or the longitudinal recess 178 may be sized such that the retaining member 162 is permitted to rotate relative to the puck 170 by the protrusion 164 rotating within the longitudinal recess 178.

The recessed portion 180 formed on the second side 174 of the puck 170, shown best in FIG. 16, is sized and configured to permit the protrusion 114 of the mounting bracket 110 to be inserted therein. In the present example, the recessed portion 180 includes a central cylindrical recess 182 and a pair of opposing recesses 184. The recesses 184 include a pair of angled walls 186 that form an angle relative to an axis 189. In some implementations, the angled walls 186 may form an angle relative to the axis 189 of ±5 degrees. In some implementations, the angled walls 186 may form other angles relative to the axis 189. When the protrusion 114 is inserted into the recessed portion 180, the angled walls 186 may permit the protrusion 114 to roll or rotate about the central axis 102, thereby permitting roll of the device mounting plate 130 about axis 102 relative to the mounting bracket 110. Accordingly, such roll or rotation may permit a user to adjust a device coupled to the device mounting bracket 130. For example, if, when the device is coupled to the device mounting bracket 130, the device is slightly askew relative to the device mounting bracket 130, the roll or rotation permitted by the protrusion 114 and recessed portion 180 interface may permit the device to be leveled without recoupling the device to the device mounting bracket 130. In another example, if the mounting bracket 110 is not level (e.g., the mounting bracket 110 is askew relative to a mounting surface or member and/or the mounting surface and/or member is not level relative to another reference point), the roll or rotation permitted by the protrusion 114 and recessed portion 180 interface may permit the device to be leveled without remounting the mounting bracket 110, mounting surface, mounting member, and/or other mounting feature. In other implementations, the opposing recesses 184 may not have angled walls 186, but instead the opposing recesses 184 and/or the recessed portion 180 may by sized to permit the protrusion 114 to rotate within the opposing recesses 184 and/or the recessed portion (e.g., the recessed portion 180 and/or the opposing recesses 184 may be oversized). In still other implementations, the recessed portion 180 and/or the opposing recesses 184 may be sized such that the mounting bracket 110 may be substantially prevented from rotating about the central axis 102.

The puck 170 further includes an opening 188 formed through the puck 170 and defined by the central axis 102. The opening 188 permits the body of the coupling member 190 to be passed through the puck 170 to couple the components of the adjustment assembly 160 and/or device mount 100 together. In the example shown in FIG. 16, the puck 170 may include ribs, or other structural members, to improve the strength and rigidity of the puck 170 while permitting the removal of material from the puck 170. For example, material may be removed from the second side 174 of the puck 170 to lighten and/or reduce the material used to create the puck 170. For example, for an injection molded puck 170, the removal of material may reduce the cost to create the puck 170. In some implementations, the puck 170 may be a substantially solid member without the ribs or other structural members.

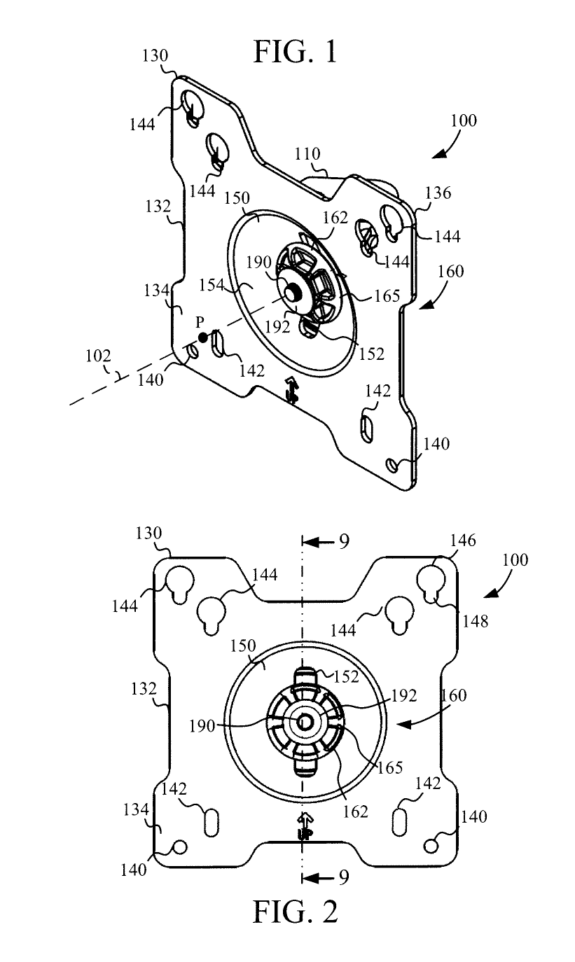

The curved inner surface 176 of the puck 170 complements the curved portion 150 and permits the device mounting plate 130 to move about the point P within a plane, such as the plane defined by cross-sectional plane 9-9 shown in FIG. 2, while the coupling member 190 slides within and along the slot 152 of the curved portion 150. Accordingly, the adjustment assembly 160 may be provided to permit the device coupled to the device mounting plate 130 to be pivoted relative to the mounting bracket 110 utilizing the adjustment assembly 160. Thus, the mounting bracket 110 may remain fixed or motionless relative to a fixing member or support, such as a wall, free-standing support member, and/or other member.

In some implementations, the device mounting plate 130, the mounting bracket 110, and the puck 170 may comprise metallic components (e.g., steel, aluminum, titanium, cast iron, etc.), thermoplastic components (e.g., HDPE, ABS, polycarbonate, etc.), and/or components made from other substantially rigid materials.

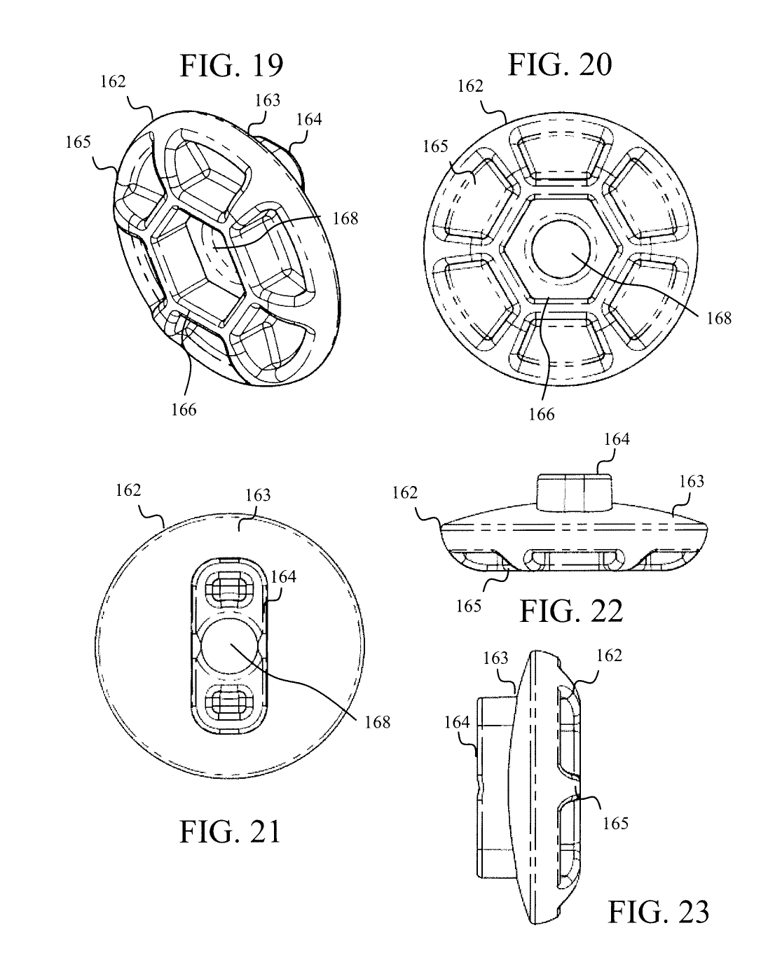

Referring to FIGS. 8 and 19-23, a retaining member 162 may be included with the adjustment assembly 160. The retaining member 162 includes a protrusion 164 extending outwardly from a rear surface 163 and a nut recess 166 formed in a front portion 165 of the retaining member 162. As noted above, the protrusion 164 of the retaining member 162 is sized and configured to insert into the longitudinal recess 178 of the puck 170 such that the retaining member 162 and the puck 170 are rotationally coupled together. In addition, the protrusion 164 and longitudinal recess 178 may have a length that may be greater than the width of the longitudinal slot 152 of the curved portion 150 such that, when the protrusion 164 is inserted into the longitudinal recess 178 of the puck 170 through the longitudinal slot 152 and having the curved portion 150 positioned between the puck 170 and the retaining member 162, the retaining member 162 and puck 170 are substantially prevented from rotating via the protrusion 164 being substantially prevented from rotating within the longitudinal slot 152 of the curved portion 150 of the device mounting plate 130. Of course, in some implementations, the protrusion 164 and/or the longitudinal recess 178 may be sized such that the retaining member 162 is permitted to rotate relative to the puck 170 by the protrusion 164 rotating within the longitudinal recess 178.

The rear surface 163 of the retaining member 162 may include a curved surface that complements the curved inner surface of the curved portion 150 of the device mounting plate 130, as can best be seen in FIG. 9. Thus, it should be understood that the rear surface 163, of the retaining member 162 the curved portion 150 of the device mounting plate 130, and the curved portion 176 of the puck 170 all have substantially the same curvature in the present example. In some implementations, the rear surface 163 and/or the inner surface of the curved portion 150 of the device mounting plate 130 may include ridging, dimpling, or other friction-inducing features to further resist movement by the adjustment assembly 160 until a predetermined force (e.g., torque) is applied to overcome the frictional resistance. In other implementations, the rear surface 163 and/or the inner surface of the curved portion 150 of the device mounting plate 130 may include friction reducing features or materials (e.g., polytetrafluoroethylene, or Teflon®, coating or the like) to reduce the resistance against movement of the adjustment assembly 160. In some implementations, the rear surface 163 may not complement the inner surface of the curved portion 150, but may be a planar surface such that the exterior edges and/or portion of the retaining member's surface engages the inner surface of the curved portion 150. In some implementations, the retaining member 162 may flex to further engage with the inner surface of the curved portion 150 of the device mounting plate 130. Of course, other configurations for the rear surface 163 may be implemented as well.

The front portion 164 of the retaining member 162 includes a nut recess 166 size to receive and rotationally engage with the nut 192 that couples to the coupling member 190. In some instances, the nut 192 may adhesively coupled to the retaining member 162 within the nut recess 166. In the present example, the front portion 164 includes ribs or other structural members to improve the strength and rigidity of the retaining member 162 while permitting the removal of material from the front portion 164 of the retaining member 162. For example, material may be removed from the front portion 164 of the retaining member 162 to lighten and/or reduce the material used to create the retaining member 162. For example, for an injection molded retaining member 162, the removal of material may reduce the cost to create the retaining member 162. In some implementations, the retaining member 162 may be a substantially solid member without the ribs or other structural members.

An opening 168 may extend through the center of the retaining member 162 and may be defined by the central axis 102 such that a component, such as the coupling member 190, may extend through retaining member 162. Accordingly, the components of the device mount 100, with the exception of the coupling member 190, may be assembled together with openings 116, 188, and 168 aligned such that the mounting bracket 110, puck 170, device mounting plate 130 and retaining member 162, and nut 192 form a stack of components, such as that shown in FIG. 9. The coupling member 190 may be inserted through openings 116, 188, and 168, respectively, and engage the interior threads of nut 192. The nut 192 may then be tightened until a desired or predetermined torque is achieved such that adjustment assembly 160 of the device mount 100 may support the device coupled to the device mounting plate 130 at a desired tilt angle relative to the mounting bracket 110 and/or fixing member or support coupled thereto. In the present example, the coupling member 190 includes a hex or allen key socket, though other bolt head engagement configurations may be used (e.g. hex heads, Robertson or square, Torx, etc.).

In some implementations, the retaining member 162 may comprise a metallic component (e.g., steel, aluminum, titanium, cast iron, etc.), a thermoplastic component (e.g., HDPE, ABS, polycarbonate, etc.), and/or components made from other substantially rigid materials. In addition, as noted above, a lock washer 194 and/or other mounting hardware may be included as well in some instances.

FIGS. 24-29 illustrate an exemplary embodiment of another device mount 200 that is configured to provide for the variable tilt adjustment of a coupled device, such as a flat screen or panel display device, relative to a fixing member or support, such as a wall and/or other member capable of supporting the combined weight of the device mount 200 and the coupled device. In this example, the device mount 200 includes a mounting bracket 210, a device mounting plate 230, a puck 270, a retaining member 262, a coupling member 290 (such as a bolt), a nut 292, and a lock washer 294. The device mounting plate 230, the puck 270, the retaining member 262, the coupling member 290, the nut 292, and the lock washer 294 of the device mount 200 may constructed, configured, and/or operate in substantial accordance with the device mounting plate 130, the puck 170, the retaining member 162, the coupling member 190, the nut 192, and the lock washer 194 described above.

The mounting bracket 210 (e.g., the second mounting portion) of the present example is configured to couple, affix, and/or otherwise attach the device mount 200 to a fixing member, such as a wall or other support member. The mounting bracket 210 shown in FIGS. 24-29 comprises a base portion 212, a pair of extension members 220 extending substantially perpendicular from the base portion 212, and a pair of attachment members 222 each extending substantially perpendicular from a respective extension member 220. In some implementations, the extension members 220 and/or the attachment members 222 may extend from angles other than perpendicular, such as oblique angles. For example, the extension members 220 may extend from the base portion 212 at an angle of 180 degrees, thereby forming a substantially planar surface with the base portion 212. Of course other angles for the extension members 220 may be used as well, such as any angle from greater than 0 degrees to 180 degrees, inclusive. Likewise, the attachment members 222 may extend from the extension members 220 at an angle of 180 degrees, thereby forming a substantially planar surface with the extension members 220. Of course other angles for the attachment members 222 may be used as well, such as any angle from greater than 0 degrees to less than 360 degrees relative to the extension members 220.

The attachment members 222 each include an opening 224 and/or or any suitable feature for coupling such that the attachment members 222 may be coupled to a fixing member, such as a wall, by a fastener (e.g., a screw, a bolt, pin, etc.). By way of example only, a bolt or screw may be inserted through openings 224 of attachment members 222 to affix the mounting bracket 210 to a fixing member, such as a wall. In some instances, the attachment members 222 may be welded to a surface via welding using the openings 224 and/or otherwise.

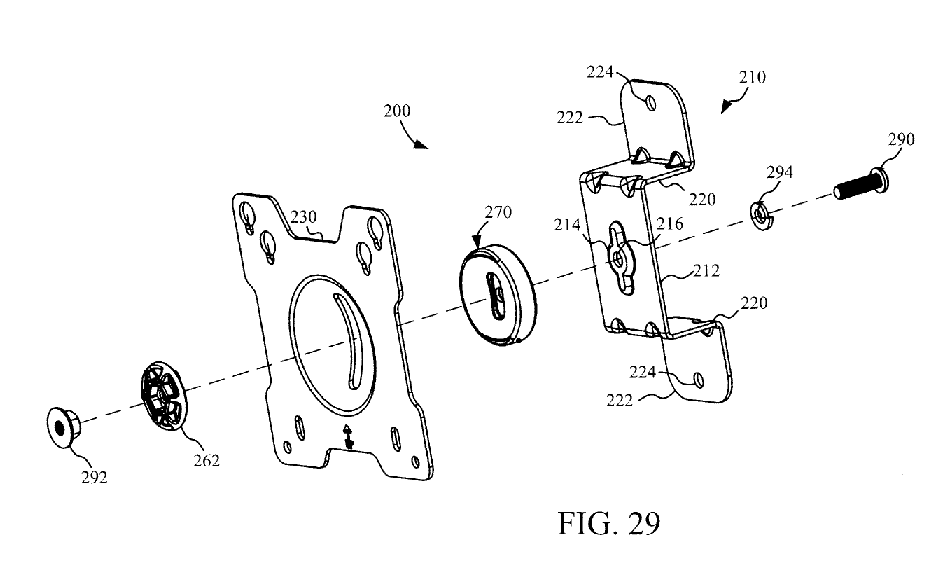

The base portion 212 of the mounting bracket 210 is configured to couple to an adjustment assembly 260 via the coupling member 290 extending through an opening 216 formed in the base portion 212 and defined by a central axis 202. In the present example, the base portion 212 includes a protrusion 214 (shown best in FIG. 29) formed on a surface of the base portion 212 opposite to the extension members 220. The protrusion 214 may be sized and configured in substantial accordance with the protrusion 114 of the device mount 100 described above.

The mounting bracket 210 of the present example may be used to mount and/or affix the device mount 200 to a planar surface, such as a wall, and/or otherwise.

FIGS. 30-34 illustrate another exemplary embodiment of another device mount 300 that is configured to provide for the variable tilt adjustment of a coupled device, such as a flat screen or panel display device, relative to a fixing member or support, such as a wall and/or other member capable of supporting the combined weight of the device mount 300 and the coupled device. In this example, the device mount 300 includes a slidable mounting member 310, a device mounting plate 330, a puck 370, a retaining member 362, a coupling member 390, a nut 392, and a lock washer 394. The device mounting plate 330, the puck 370, the retaining member 362, the coupling member 390, the nut 392, and the lock washer 394 of the device mount 300 may constructed, configured, and/or operate in substantial accordance with the device mounting plate 130, the puck 170, the retaining member 162, the coupling member 190, the nut 192, and the lock washer 194 described above.

In the present example, the slidable mounting member 310 configured to slidably insert at least a portion of the slidable mounting member 310 into and/or couple to a channel or other member to couple the device mount 300 thereto. In the present example, the slidable mounting member 310 includes a base portion 312, a pair of opposing L-shaped members 320, and a top member 326.

The L-shaped members 320 extend substantially perpendicular from the base portion 312. In some implementations, the L-shaped members 320 may extend from angles other than perpendicular, such as oblique angles. For example, the L-shaped members 320 may extend from the base portion 312 at an angle of 180 degrees. Of course other angles for the L-shaped members 320 may be used as well, such as any angle from greater than 0 degrees to 180 degrees, inclusive. The L-shaped members 320 include a first portion 322 that extends from the base portion 312 and a second portion 324 that extends from the first portion 322. In the present example, the first portion 322 has a substantially trapezoidal shape with a ramped lower portion and ramped upper portion. The ramped lower portion may permit a user to align the second portion 324 of the L-shaped members 320 with a channel or slot into which the slidable mounting member 310 is to be, at least partially, inserted.

The top member 326 also extends substantially perpendicular from the base portion 312 and is positioned between the opposing L-shaped members 320. In the present example, the top member 326 includes a slot 328 that may be use to affix and/or otherwise coupled the slidable mounting member 310 to a surface or other member to hold the slidable mounting member 310 in a fixed position relative to the channel or slot into which at least a portion of the slidable mounting member 310 has been inserted.

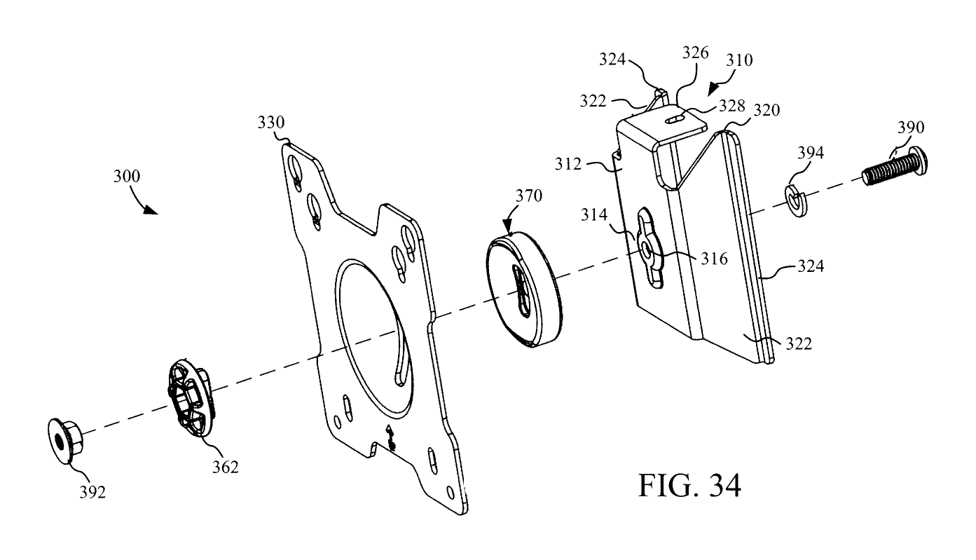

The base portion 312 of the slidable mounting member 310 is configured to couple to an adjustment assembly 360 via the coupling member 390 extending through an opening 316 formed in the base portion 312 and defined by a central axis 302. In the present example, the base portion 312 includes a protrusion 314 (shown best in FIG. 34) formed on a surface of the base portion 312 opposite to the L-shaped members 320 and/or top member 326. The protrusion 314 may be sized and configured in substantial accordance with the protrusion 114 of the device mount 100 described above.

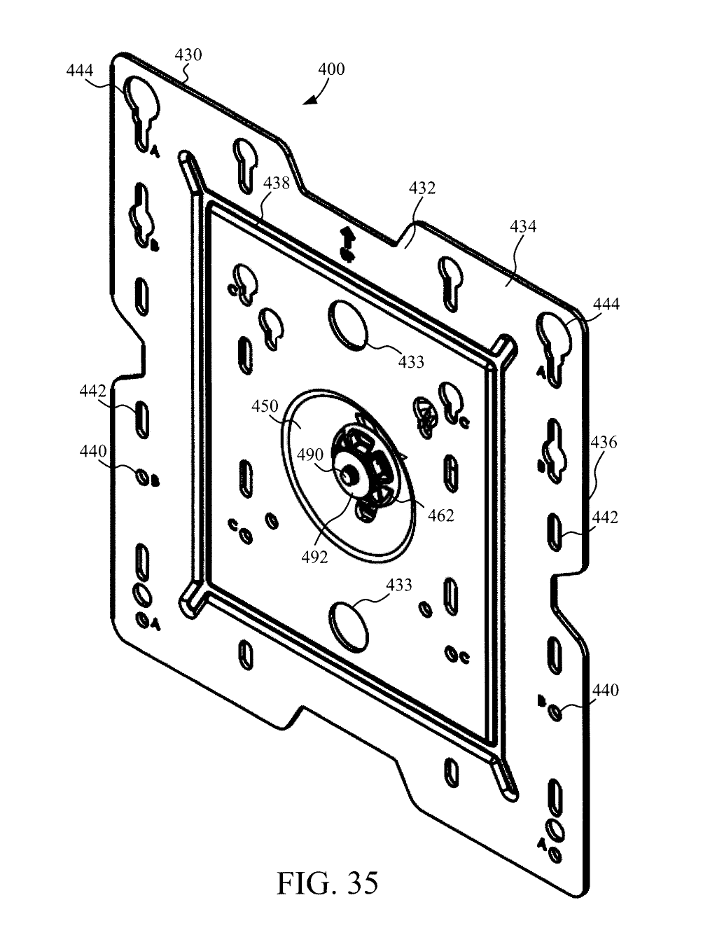

FIG. 34-35 illustrate still another exemplary embodiment of a device mount 400 that is configured to provide for the variable tilt adjustment of a coupled device, such as a flat screen or panel display device, relative to a fixing member or support, such as a wall and/or other member capable of supporting the combined weight of the device mount 400 and the coupled device. In this example, the device mount 400 includes a mounting bracket 410, a device mounting plate 430, a puck 470, a retaining member 462, a coupling member 490, a nut 492, and a lock washer 494. The mounting bracket 410, the puck 470, the retaining member 462, the coupling member 490, the nut 492, and the lock washer 494 of the device mount 400 may constructed, configured, and/or operate in substantial accordance with the mounting bracket 110, the puck 170, the retaining member 162, the coupling member 190, the nut 192, and the lock washer 194 described above. In some implementations, a mounting bracket substantially similar to the mounting bracket 210 shown in FIGS. 24-29 and/or a slidable mounting member substantially similar to the slidable mounting member 310 shown in FIGS. 30-34 may be used instead of mounting bracket 410.

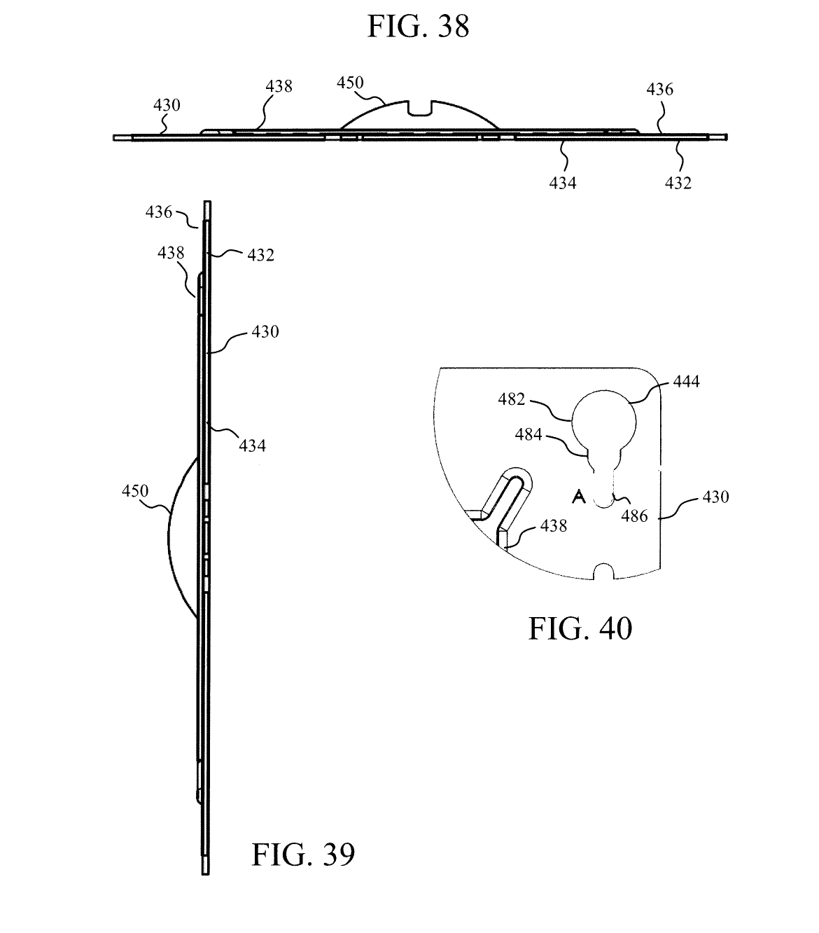

Referring to FIGS. 35-40, the device mounting plate 430 (e.g., the first mounting portion) is adapted to secure a device (e.g., a display device) to the device mount 400. For example, the device mounting plate 430 may be coupled to an adjustment assembly 460 of the device mount 400, whereby the tilt orientation of a secured display device is adjustable relative to the support member (and/or the mounting bracket 410) via the adjustment assembly 460.

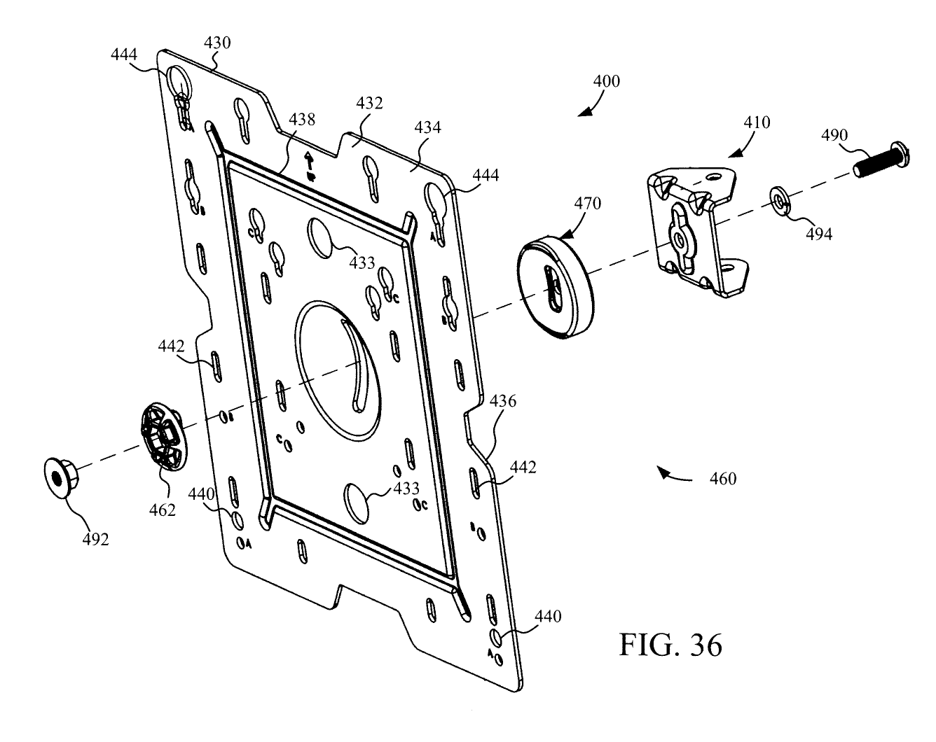

The device mounting plate 430 includes a base 432 having a first side 434 and a second side 436 and that is configured to couple to and/or otherwise receive and/or be attached to a device. The device mounting plate 430 may also include forms, flanges, ribs, or other structural members to improve the strength and rigidity of the device mounting plate 430. For example, in the present example, the device mounting plate 430 includes a channel 438 formed therein to assist in resisting flexure of the device mounting plate 430. As shown in FIG. 36, the base 432 of the device mounting plate 430 includes a substantially planar base 432 that may be abutted against a device having one or more attachment points (e.g., bolt openings or other attachment mechanisms). The device mounting plate 430 and/or the base 432 may also include voids or lightening openings, such as lightening openings 433, to reduce the mass of the device mounting plate 430 and/or the base 432. The mass reduction voids may be varied in size and location, based on the desired mass and/or strength of the device mounting plate 430 and/or the base 432.

In the present example, the base 432 includes several attachment openings 440, several attachment slots 442, and several variable attachment openings 444. The attachment openings 440, attachment slots 442, and/or variable attachment openings 444 may be positioned in base 432 to form a flat display mounting interface (FDMI). The attachment openings 440, attachment slots 442, and/or variable attachment openings 444 may be positioned to form one or more VESA patterns, such as 75 millimeters (mm) by 75 millimeters (mm), 100 mm by 100 mm, 200 mm by 100 mm, 100 mm by 200 mm, 200 mm by 200 mm, 300 mm by 300 mm, 400 mm by 400 mm, 400 mm by 200 mm, combinations thereof, and/or any other suitable pattern.

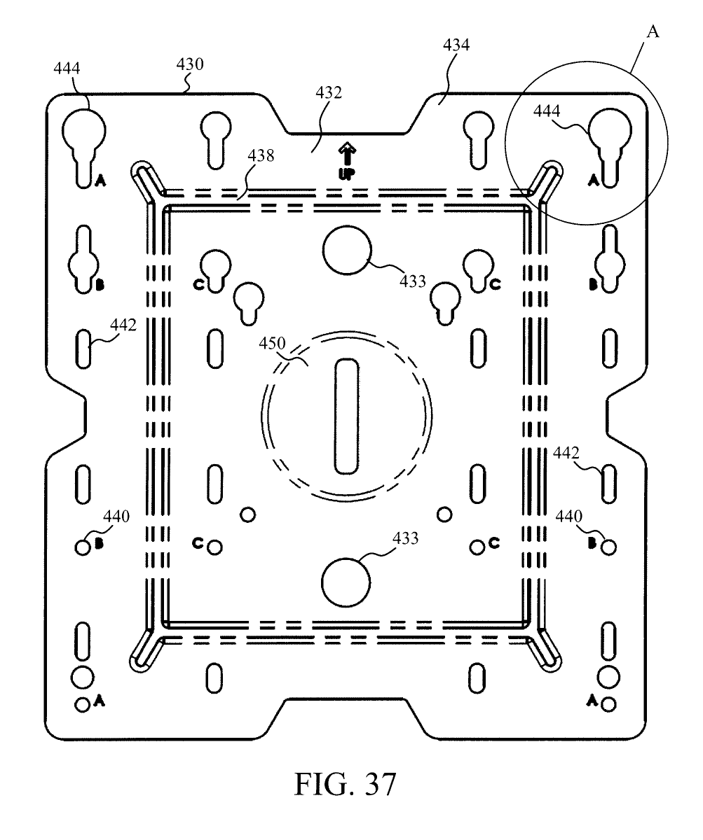

In some implementations, the attachment openings 440, attachment slots 442, and/or variable attachment openings 444 may be sized to receive mounting hardware, such as M4, M5, M6, and/or M8 mounting hardware. In some implementations, such as that shown in the detail FIG. 40 of detail A shown in FIG. 37, the variable attachment openings 444 may be configured to have a common mounting opening pattern such that the variable attachment openings 444 may be capable of receiving multiple sizes of mounting hardware (such as M4, M5, M6, and/or M8 mounting hardware), thereby permitting the device mounting plate 430 to be coupled using a variety of mounting hardware. For example, as shown in FIG. 40, an example variable attachment opening 444 includes an upper portion 482, a middle portion 484, and a lower portion 486. In the present example, the upper portion 482 may be size to permit the head of a mounting screw or other mounting hardware to fit therethrough. For example the head of M4, M5, M6, and/or M8 mounting hardware. The middle portion 484 may be size to receive and engage the bodies of M6 and M8 mounting hardware while the lower portion 486 may be sized to receive the bodies of M4 and M5 mounting hardware. Thus, when M6 or M8 mounting hardware is used, the head of the mounting hardware may pass through the upper portion 482 and engage the middle portion 484 such that the middle portion 484 supports the body of the M6 or M8 hardware. Similarly, when M4 or M5 mounting hardware is used, the head of the mounting hardware may pass through the upper portion 482 and the middle portion 484 and engage the lower portion 486 such that the lower portion 486 supports the body of the M4 or M5 hardware. Accordingly, the device mounting plate 430 may be usable with a wide variety of devices having varying mounting hardware sizes and/or mounting pattern configurations. Of course, other sizes of mounting hardware and/or sizes for the portions of the variable attachment opening 444 may be used as well. In some implementations, the middle portion 484 may be omitted such that only an upper portion 482 and lower portion 486 are used. Referring to FIG. 37, in some instances the lower portion 486 of the variable attachment openings 444 may have a slotted lower portion 486 of a constant width that extends away from the upper portion 482. In some other instances, the lower portion 486 may continuously decrease to a point, thereby forming an inverted tear-drop shape for the variable attachment openings 444.

It should be understood that the lower portion 486 may provide both a vertical support surface against which the mounting hardware (and therefore the device) may be supported by the device mounting plate 430 (e.g., to prevent the device from falling due to gravity) and couple the device to the device mounting plate 430 by the providing a horizontal support surface against which the head of the mounting screw or bolt may abut. In some instances, the vertical support surface may be at the bottom of the lower portion 486 and/or may be at any other point along the lower portion 486, such as where the lower portion 486 narrows continuously in a V-shaped manner and/or in a stepped manner, such as that shown in FIG. 40.

The variable attachment openings 444 enable a user to mount a device to the device mounting plate 430 without decoupling or detaching the device mounting plate 430 from the remainder of the device mount 400. In addition, the variable attachment openings 444 enable a single user to attach a device to the device mounting plate 430 without assistance from another individual. For example, to affix a device to the base 432 of the device mounting plate 430, at least two screws or mounting hardware may initially be coupled to at least two upper attachment points (e.g., screw or bolt openings) of the device on opposing sides of the center of gravity for the device. The user may then align the heads of the mounting screws or other hardware with the upper portions 482 of at least two of the variable attachment openings 444. The user may then insert the heads of the mounting screws or other hardware through the upper portions 482 such that the device is on the first side 434 of the base 432 and the heads of the mounting screws or other hardware protrudes through to the second side 436. The user may then lower the device until the bodies of the mounting screws or other hardware contact and are substantially supported by the lower portion 486 of the variable attachment openings 444 through which the heads of the mounting screws or other hardware were inserted.

With the device substantially supported by the at least two upper mounting screws or other hardware, the user may attach one or more additional mounting screws or other hardware to the device through one or more of the attachment openings 440, attachment slots 442, and/or other variable attachment openings 444, depending upon how the attachment points of the device align with the attachment openings 440, attachment slots 442, and/or other variable attachment openings 444. In some implementations, the user may tighten the mounting screws or other hardware inserted through the attachment openings 440, attachment slots 442, and/or other variable attachment openings 444 to a desired torque level (such as that provided by a device manufacturer and/or otherwise). With the lower mounting screws or other hardware affixing the device to the base 432 of the device mounting base 430, the user may tighten the mounting screws or other hardware previously inserted through the variable attachment openings 444 to a desired torque level (such as that provided by a device manufacturer and/or otherwise). Accordingly, the device may be substantially secured to the device mounting plate 430 of the device mount 400. If the device mount 400 is coupled to and/or otherwise affixed to a fixing member, such as a support member, free-standing support, etc., then the device may be substantially supported by the device mount 400 via the device mounting plate 430, through the adjustment assembly 460, to the mounting bracket 410 or other mounting member (e.g., a slidable mounting member).

The device mounting plate 430 further includes a raised curved portion 450 extending from the second side 436 of the device mounting plate 430. The curved portion 450 may be constructed, configured, and/or otherwise operate in accordance with the curved portion 150 described in reference to FIGS. 1-13 for device mount 100.

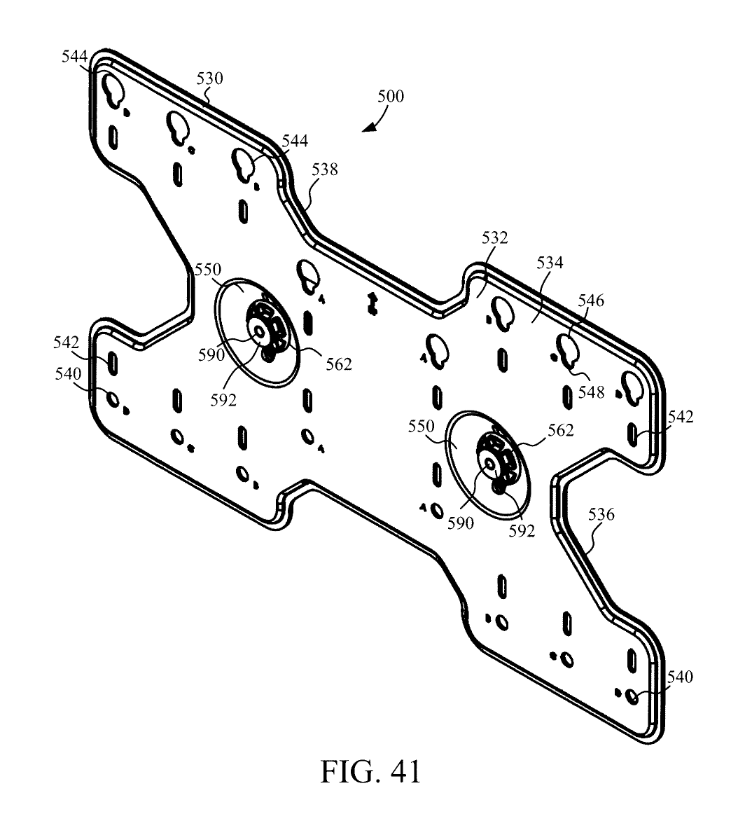

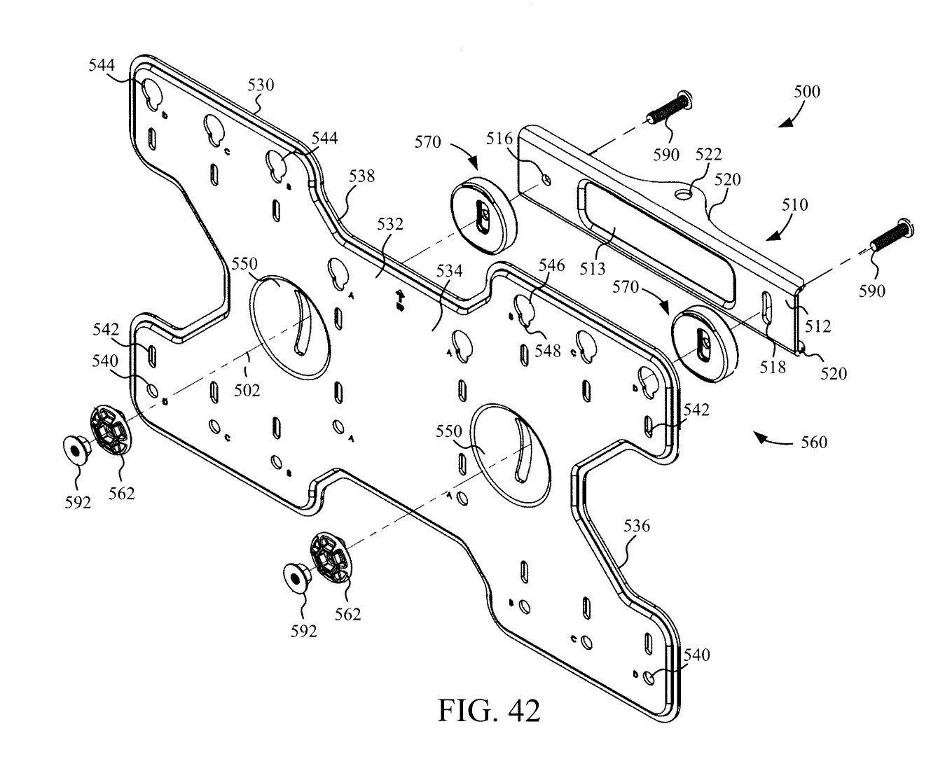

FIGS. 41-42 illustrate yet another exemplary embodiment of a device mount 500 that is configured to provide for the variable tilt adjustment of a coupled device, such as a flat screen or panel display device, relative to a fixing member or support, such as a wall and/or other member capable of supporting the combined weight of the device mount 500 and the coupled device. In this example, the device mount 500 includes a mounting bracket 510, a device mounting plate 530, a pair of pucks 570, a pair of retaining members 562, a pair of coupling members 590, and a pair of nuts 592. The pair of pucks 570, the pair of retaining members 562, the pair of coupling members 590, and the pair of nuts 592 may constructed, configured, and/or operate in substantial accordance with the puck 170, the retaining member 162, the coupling member 190, and the nut 192 described above. Additional mounting hardware, such as washers, lock washers, etc. may be utilized as well.

Referring to FIG. 42, the mounting bracket 510 (e.g., the second mounting portion) of the present example is configured to couple, affix, and/or otherwise attach the device mount 500 to a fixing member, such as a support member, free-standing support, etc. The mounting bracket 510 comprises a base portion 512 and a pair of attachment members 520 extending substantially perpendicular from the base portion 512. In some implementations, the attachment members 520 may extend from angles other than perpendicular, such as oblique angles. For example, the attachment members 520 may extend from the base portion 512 at an angle of 180 degrees, thereby forming a substantially flat plate for mounting bracket 510. Of course other angles for the attachment members 520 may be used as well, such as any angle from greater than 0 degrees to 180 degrees, inclusive.

The attachment members 520 each include an opening 522 and/or or any suitable feature for coupling such that the attachment members 520 may be coupled to a fixing member and/or otherwise affixed, pinned, etc. to a fixing member by a fastener (e.g., a bolt, pin, etc.). By way of example only, a pin (not shown) may be inserted through openings 522 of attachment members 520 to couple the mounting bracket 510 to a support member (also not shown). In some implementations, the pin, fixing member, and mounting bracket 510 may form a joint that pivots about an axis defined by openings 522. Of course, in some instances, the attachment members 520 may be affixed or otherwise attached to a fixing member such that the mounting bracket 510 may not be pivotable or otherwise movable relative to the support member. For example, the attachment members 120 may be bolted, welded, and/or otherwise affixed to a fixing member.

The base portion 512 of the mounting bracket 510 is configured to couple to a pair of adjustment assemblies 560 via the coupling members 590 extending through an opening 516, defined by axis 502, and a curved slot 518 formed in the base portion 512. The curved slot 518 may have a curvature such that the distance from the opening 516 remains constant (e.g., the slot may be defined by a radius extending from opening 516). Accordingly, the curved slot 518 may permit roll adjustment about axis 502 to level the device mount 500 via the coupling member 590 sliding within the curved slot 518. For example, the length of the curved slot 518 may be such that the roll adjustment about the axis 502 is ±5 degrees. In some implementations, the length of the curved slot 518 may be such that the roll adjustment about the axis 502 permits other angles of roll adjustment about axis 502.

Thus, the curved slot 518 may permit the device mounting plate 530 to roll or rotate about the axis 502 relative to the mounting bracket 510. Accordingly, such roll or rotation may permit a user to adjust a device coupled to the device mounting bracket 530. For example, if, when the device is coupled to the device mounting bracket 530, the device is slightly askew relative to the device mounting bracket 530, the roll or rotation permitted by the curved slot 518 may allow the device to be leveled without recoupling the device to the device mounting bracket 530. In another example, if the mounting bracket 510 is not level (e.g., the mounting bracket 510 is askew relative to a fixing member and/or the fixing member is not level relative to another reference point), the roll or rotation permitted by the curved slot 518 may allow the device to be leveled without remounting the mounting bracket 510, fixing member, and/or other member.

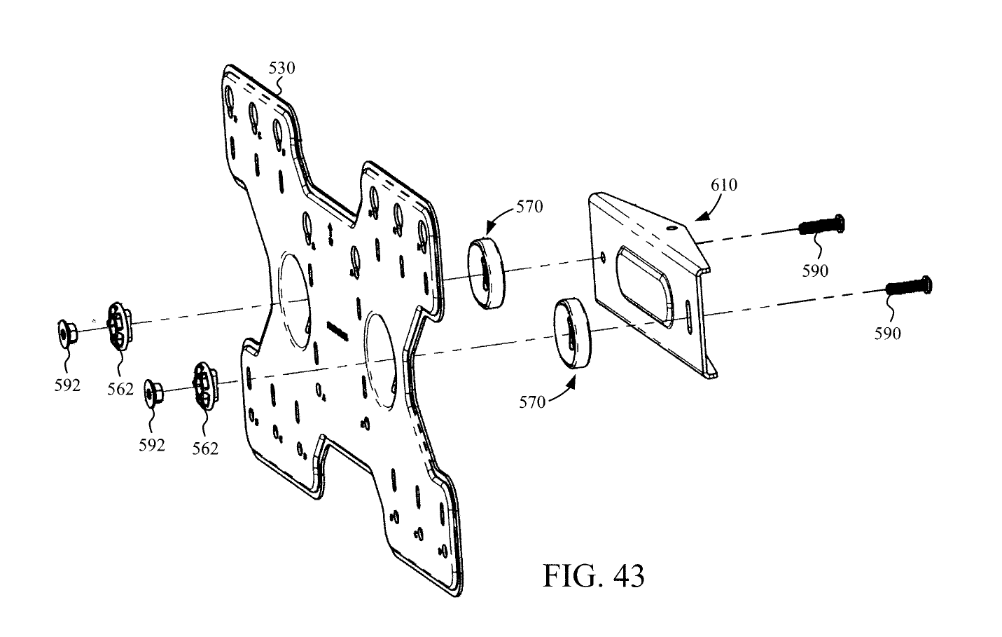

The base portion 512 may also include voids or lightening openings, such as lightening opening 513, to reduce the mass of the mounting bracket 510. The mass reduction voids may be varied in size and location, based on the desired mass and/or strength of the mounting bracket 510. An alternative mounting bracket 610, shown in FIG. 43, is substantially similar to the mounting bracket 510 described herein and may be used with device mount 500.

Referring to FIGS. 41-43, the device mounting plate 530 (e.g., the first mounting portion) is adapted to secure a device (e.g., a display device) to the device mount 500. For example, the device mounting plate 530 may be coupled to the pair of adjustment assemblies 560 of the device mount 500, whereby the tilt orientation of a secured display device is adjustable relative to the support member (and/or the mounting bracket 510, 610) via the adjustment assemblies 560.

The device mounting plate 530 includes a base 532 having a first side 534 and a second side 536 and that is configured to couple to and/or otherwise receive and/or be attached to a device. In the present example, the base 532 of the device mounting plate 530 substantially forms an X shape. The device mounting plate 530 may also include forms, flanges, ribs, or other structural members to improve the strength and rigidity of the device mounting plate 530. For example, in the present example, the device mounting plate 530 includes a flange 538 formed on the exterior of the device mounting plate 530 assist in resisting flexure of the device mounting plate 530. The base 532 of the device mounting plate 530 includes a substantially planar base 532 that may be abutted against a device having one or more attachment points (e.g., bolt openings or other attachment mechanisms). The device mounting plate 530 and/or the base 532 may also include voids or lightening openings to reduce the mass of the device mounting plate 530 and/or the base 532. The mass reduction voids may be varied in size and location, based on the desired mass and/or strength of the device mounting plate 530 and/or the base 532.

In the present example, the base 532 includes several attachment openings 540, several attachment slots 542, and several variable attachment openings 544. The attachment openings 540, attachment slots 542, and/or variable attachment openings 544 may be positioned in base 532 to form a flat display mounting interface (FDMI). The attachment openings 540, attachment slots 542, and/or variable attachment openings 544 may be positioned to form one or more VESA patterns, such as 75 millimeters (mm) by 75 millimeters (mm), 100 mm by 100 mm, 200 mm by 100 mm, 100 mm by 200 mm, 200 mm by 200 mm, 300 mm by 300 mm, 400 mm by 400 mm, 400 mm by 200 mm, combinations thereof, and/or any other suitable pattern.

In some implementations, the attachment openings 540, attachment slots 542, and/or variable attachment openings 544 may be sized to receive mounting hardware, such as M4, M5, M6, and/or M8 mounting hardware. In some implementations, such as that shown in FIG. 40, the variable attachment openings 544 may be configured to have a common mounting opening pattern such that the variable attachment openings 544 may be capable of receiving multiple sizes of mounting hardware (such as M4, M5, M6, and/or M8 mounting hardware), thereby permitting the device mounting plate 530 to be coupled using a variety of mounting hardware. Accordingly, the device mounting plate 530 may be usable with a wide variety of devices having varying mounting hardware sizes and/or mounting pattern configurations.

The variable attachment openings 544 include an upper portion 546 and a lower portion 548. In the present example the upper portion 546 is sized and configured such that the head of a mounting screw, bolt, and/or other hardware is capable of being passed through the upper portion 546 while the mounting hardware is attached to another object, such as the device to be attached to the device mounting plate 530. The lower portion 548 of the variable attachment openings 544 is size to accommodate the body of the one or more mounting hardware components. In some instances the lower portion 548 of the variable attachment openings 544 may have a slotted lower portion 548 of a constant width that extends away from the upper portion 546. In some other instances, the lower portion 548 may continuously decrease to a point, thereby forming an inverted tear-drop shape for the variable attachment openings 544. In yet other instances, the lower portion 548 may have discrete steps or tiers. Accordingly, the lower portion 548 may accommodate various mounting hardware having different body sizes (e.g., M4, M5, M6, and/or M8 mounting hardware). It should be understood that the lower portion 548 may provide both a vertical support surface against which the mounting hardware (and therefore the device) may be supported by the device mounting plate 530 (e.g., to prevent the device from falling due to gravity) and couple the device to the device mounting plate 530 by the providing a horizontal support surface against which the head of the mounting screw or bolt may abut. In some instances, the vertical support surface may be at the bottom of the lower portion 548 and/or may be at any other point along the lower portion 548, such as where the lower portion 548 narrows continuously in a V-shaped manner and/or in a stepped manner, such as that shown in FIG. 40.

The variable attachment openings 544 enable a user to mount a device to the device mounting plate 530 without decoupling or detaching the device mounting plate 530 from the remainder of the device mount 500. In addition, the variable attachment openings 544 enable a single user to attach a device to the device mounting plate 530 without assistance from another individual. For example, to affix a device to the base 532 of the device mounting plate 530, at least two screws or mounting hardware may initially be coupled to at least two upper attachment points (e.g., screw or bolt openings) of the device on opposing sides of the center of gravity for the device. The user may then align the heads of the mounting screws or other hardware with the upper portions 546 of at least two of the variable attachment openings 544. The user may then insert the heads of the mounting screws or other hardware through the upper portions 446 such that the device is on the first side 534 of the base 532 and the heads of the mounting screws or other hardware protrudes through to the second side 536. The user may then lower the device until the bodies of the mounting screws or other hardware contact and are substantially supported by the lower portion 548 of the variable attachment openings 544 through which the heads of the mounting screws or other hardware were inserted.

With the device substantially supported by the at least two upper mounting screws or other hardware, the user may attach one or more additional mounting screws or other hardware to the device through one or more of the attachment openings 540, attachment slots 542, and/or other variable attachment openings 544, depending upon how the attachment points of the device align with the attachment openings 540, attachment slots 542, and/or other variable attachment openings 544. In some implementations, the user may tighten the mounting screws or other hardware inserted through the attachment openings 540, attachment slots 542, and/or other variable attachment openings 544 to a desired torque level (such as that provided by a device manufacturer and/or otherwise). With the lower mounting screws or other hardware affixing the device to the base 532 of the device mounting base 530, the user may tighten the mounting screws or other hardware previously inserted through the variable attachment openings 544 to a desired torque level (such as that provided by a device manufacturer and/or otherwise). Accordingly, the device may be substantially secured to the device mounting plate 530 of the device mount 500. If the device mount 500 is coupled to and/or otherwise affixed to a fixing member, such as a support member, free-standing support, etc., then the device may be substantially supported by the device mount 500 via the device mounting plate 530, through the adjustment assemblies 560, to the mounting bracket 510 or other mounting member (e.g., a slidable mounting member). In some implementations, multiple devices may be coupled to the device mounting plate 530.

The device mounting plate 530 further includes a pair of raised curved portions 550 extending from the second side 536 of the device mounting plate 530. The curved portions 550 may be constructed, configured, and/or otherwise operate in accordance with the curved portion 150 described in reference to FIGS. 1-13 for device mount 100. In the present example, the curved portions 550 are equidistant from the center of the device mounting plate 530.

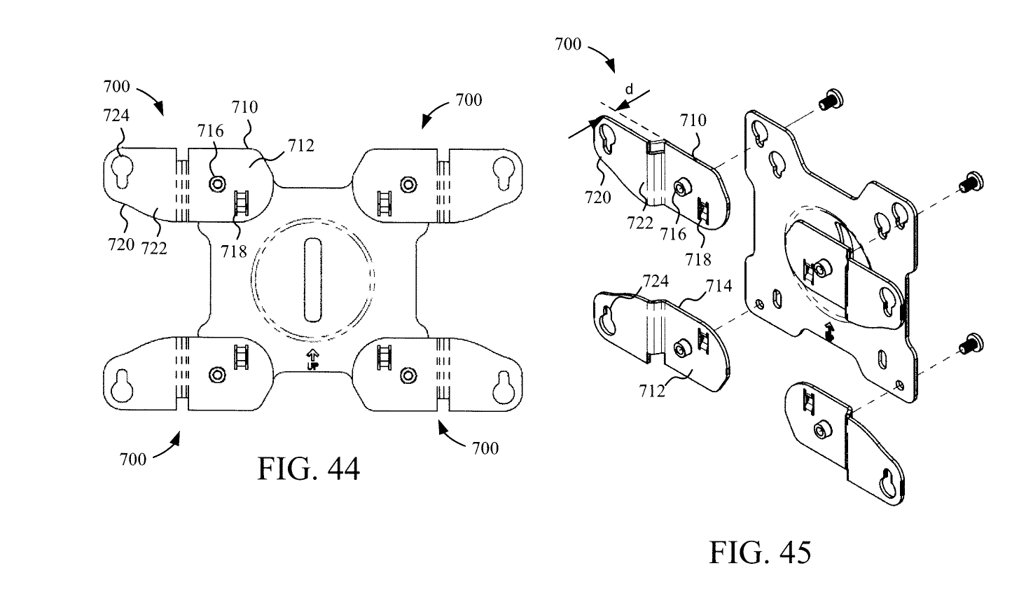

FIGS. 44-45 illustrate an exemplary embodiment of a device mount, such as device mounts 100, 200, 300, having wing extension plates 700. Right wing extension plate and left wing extension plates may be provided, though it should be understood that the wing extension plates 700 may substantially comprise mirror image of each other.

Each wing extension plate 700 includes a base portion 710 and an extension portion 720. The base portion 710 includes a threaded member 716 that protrudes from a first side 712 of the base portion 710 and a tab member 718 that extends outwardly from the second side 714. The tab member 718 of the present example forms a protruding bump such that the tab member 718 may be inserted into a lower portion of a variable attachment opening and/or into an attachment slot of the device mounting plate. The tab member 718 may be size and configured such that the tab member 718 resists rotation of the wing extension plate 700 relative to a device mounting plate of the device mount when the tab member 718 is inserted into the variable attachment opening and/or an attachment slot. In another implementation, the tab member 718 may be an s-curve having a free end such that the tab member 718 may retain a portion of a plate, such as device mounting plate 130, between the free end of the tab member 718 and the base portion 710. Of course, other tab members 718 and/or other clipping, clamping, coupling, etc. member may be used.

The extension portion 720 may be offset from the base portion 710 a distance, d, shown in FIG. 45, such that a top surface of the threaded member 716 is coplanar with the surface of the first side 722 of the extension member 720. Accordingly, the extension portion 720 and the threaded member 716 may lie flush against a rear surface of the device to which the device mount with wing extension plates 700 is to be attached. The extension portion 720 further includes a variable attachment opening 724. The variable attachment opening 724 may be configured in accordance with the teachings for variable attachment opening 144 described above.

Referring to FIG. 45, the second side 714 of the base portion 710 of a wing extension plate 700 may be placed to abut the first side of a base of a device mounting plate, such as the first side 134 of the base 132 of the device mounting plate 130 described above. The tab member 718 may initially be inserted into a variable attachment opening or attachment slot of the device mounting plate, such as variable attachment opening 144 or attachment slot 142 of device mounting plate 130. The threaded member 716 may be aligned with a portion of another variable attachment opening or an attachment opening of the device mounting plate, such as a lower portion 148 of a variable attachment opening 144 or attachment opening 140, such that a mounting screw or other hardware may couple the wing extension plate 700 to the device mounting plate by threading into threaded member 716. In the example shown in FIG. 45, four wing extension plates 700 are coupled to the device mounting plate to provide extended variable attachment openings 724 as a predetermined distance away from the device mounting plate. The predetermined distance may be 50 mm, 75 mm, 100 mm, 150 mm, 200 mm, and/or any other suitable distance. Accordingly, the wing extension plates 700 may be utilized to modify a device mounting plate, such as device mounting plates 100, 200, 300 described herein, for larger VESA and/or other mounting opening patterns. In some implementations, the extension portion 720 may be angled relative to the base portion 710 in a similar manner as extension portion 820 of wing extension plates 800 described below.

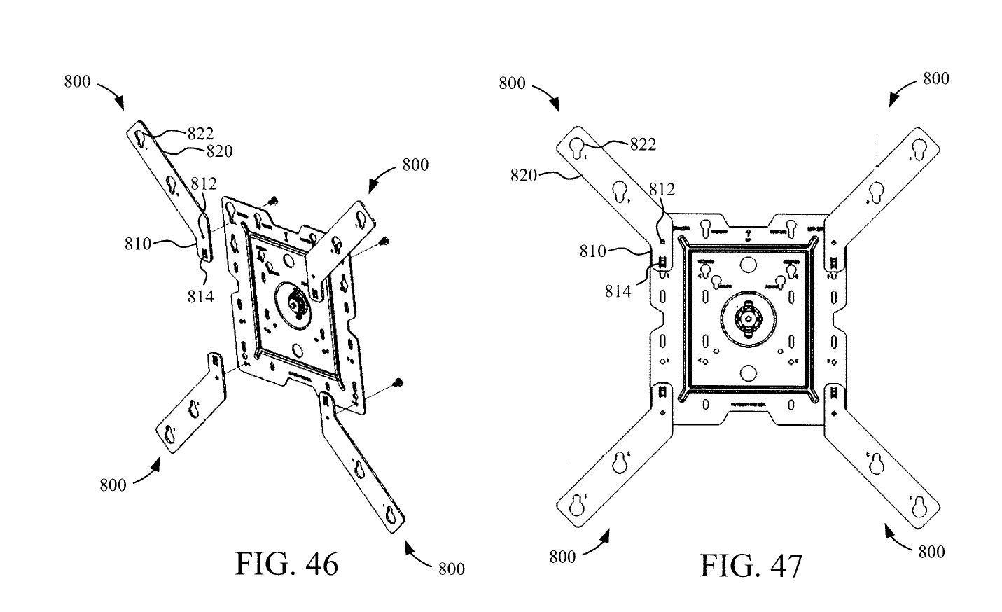

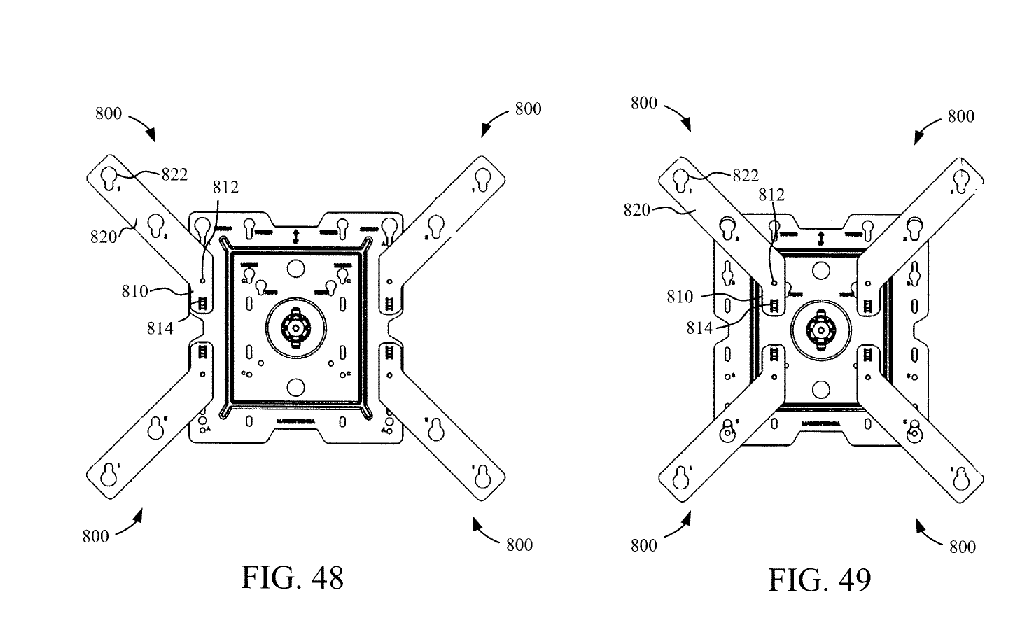

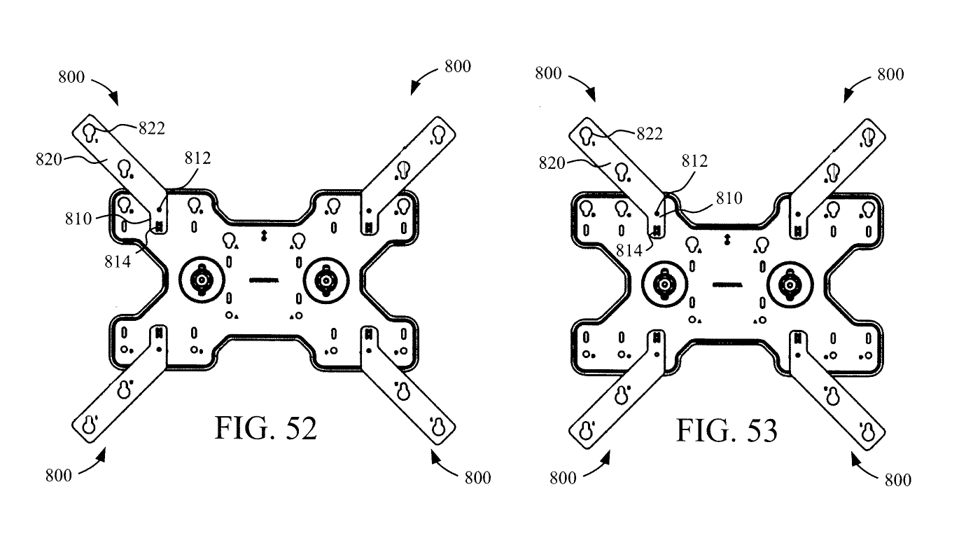

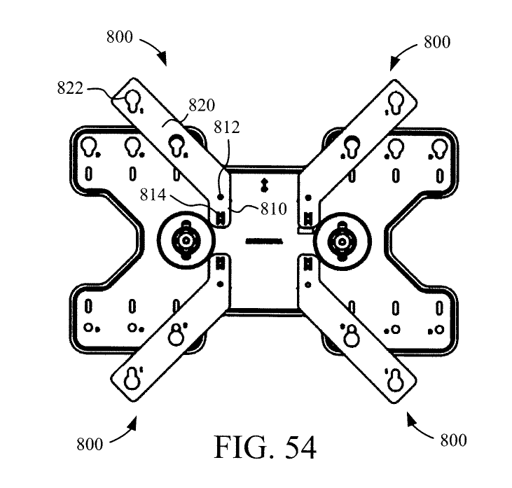

FIGS. 46-54 illustrate exemplary embodiments of a device mount, such as device mounts 400, 500, having alternative wing extension plates 800. Right wing extension plates and left wing extension plates may be provided, though it should be understood that the wing extension plates 800 may substantially comprise mirror image of each other.

Referring to FIGS. 46-47, the wing extension plate 800 includes a mounting portion 810 and an extension portion 820. The mounting portion 810 includes a threaded opening 812 and a tab member 814 that extends outwardly from a surface of the mounting portion 810. The tab member 814 of the present example forms a protruding bump such that the tab member 814 may be inserted into a lower portion of a variable attachment opening and/or into an attachment slot of the device mounting plate. The tab member 814 may be size and configured such that the tab member 814 resists rotation of the wing extension plate 800 relative to a device mounting plate of a device mount when the tab member 814 is inserted into the variable attachment opening and/or an attachment slot. In another implementation, the tab member 814 may be an s-curve having a free end such that the tab member 814 may retain a portion of a plate, such as device mounting plate 430, 530, between the free end of the tab member 814 and the mounting portion 810. Of course, other tab members 814 and/or other clipping, clamping, coupling, etc. member may be used.

The extension portion 820 of the present example extends at substantially a 45 degree angle from the mounting portion 810. Of course, extension portion 820 may extend at other angles, such as from 0 degrees, inclusive, to 360 degrees. The extension portion also includes one or more variable attachment openings 822. The variable attachment openings 822 may be configured in accordance with the teachings for variable attachment opening 144 described above.

Referring to FIG. 49, the mounting portion 810 of a wing extension plate 800 may be placed to abut the first side of a base of a device mounting plate, such as the first side 434 of the base 432 of the device mounting plate 430 described above. The tab member 814 may initially be inserted into a variable attachment opening or attachment slot of the device mounting plate, such as variable attachment opening 444 or attachment slot 442 of device mounting plate 430. The threaded opening 812 may be aligned with a portion of another variable attachment opening, an attachment opening, and/or an attachment slot of the device mounting plate, such as a lower portion 448 of a variable attachment opening 444, attachment opening 440 and/or attachment slot 442, such that a mounting screw or other hardware may couple the wing extension plate 800 to the device mounting plate by threading into threaded opening 812. In the example shown in FIG. 49, four wing extension plates 800 are coupled to the device mounting plate to provide extended variable attachment openings 822 as a predetermined distance vertically and/or horizontally away from the device mounting plate. The predetermined vertical and/or horizontal distances may be 50 mm, 75 mm, 100 mm, 150 mm, 200 mm, and/or any other suitable vertical or horizontal distance. Accordingly, the wing extension plates 800 may be utilized to modify a device mounting plate, such as device mounting plates 400, 500 described herein, for larger VESA and/or other mounting opening patterns.

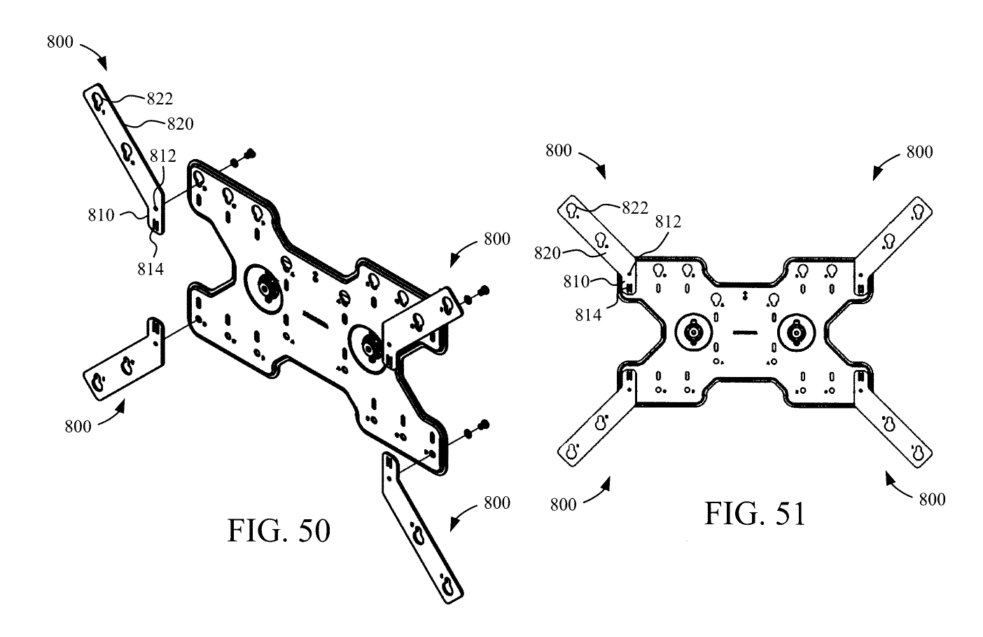

FIGS. 50-54 illustrate various alternative configurations and attachment points for wing extension plates 800 for device mounts 400, 500 and device mounting plates 430, 530.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

It is important to note that the construction and arrangement of the device mounts and the adjustment mechanisms, as shown in the various exemplary embodiments, are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A mounting system for supporting an audio/visual device, comprising:
a first mounting portion configured to operatively connect to the audio/visual device, the first mounting portion having a curved portion, wherein the curved portion has a slot;
a second mounting portion configured to couple to the first mounting portion and to a mounting member, wherein the second mounting portion has a first opening;
a puck disposed between the first mounting portion and the second mounting portion, the puck including:
a curved inner surface, wherein the curved inner surface complements the curved portion of the first mounting portion, and
a second opening; and
a coupling member configured to insert, at least partially, through the slot, the first opening, and the second opening, wherein the coupling member couples the first mounting portion, the puck, and the second mounting portion;
wherein the first mounting portion is pivotable relative to the second mounting portion.

2. The mounting system of claim 1, wherein first mounting portion further has a variable attachment opening, wherein the variable attachment opening has an upper portion and a lower portion, wherein the upper portion is sized to permit a first head of a first fastener to pass therethrough, wherein the lower portion is sized to substantially prevent the first head of the first fastener from passing therethrough, and wherein the lower portion is sized to engage a first body of the first fastener.

3. The mounting system of claim 2, wherein the variable attachment opening has a middle portion, wherein the middle portion is situated between the upper portion and the lower portion, wherein the middle portion is sized to engage a second body of a second fastener, wherein the first body is smaller than the second body, wherein the first body of the first fastener does not engage the middle portion.

4. The mounting system of claim 2, wherein the variable attachment opening of the first mounting portion is configured to couple to the first fastener when the first fastener is coupled to the audio/visual device.

5. The mounting system of claim 1, further comprising a retaining member, wherein the retaining member includes a protrusion and a third opening, wherein the protrusion is configured to extend, at least partially, through the slot of the curved portion of the first mounting portion, wherein the coupling member is further configured to insert through the third opening to couple the retaining member to the first mounting portion, the puck, and the second mounting portion, wherein the protrusion slides along the slot when the first mounting portion is pivoted relative to the second mounting portion.

6. The mounting system of claim 5, wherein the puck further includes a recessed portion in the curved inner surface, wherein the recessed portion is configured to receive at least a portion of the protrusion of the retaining member.

7. The mounting system of claim 6, wherein the retaining member further includes a surface, the protrusion extending outwardly from the surface, and wherein the surface has a curvature that substantially complements a curvature of an inner surface of the curved portion of the first mounting portion.

8. The mounting system of claim 1, wherein the second mounting portion further includes a second mounting portion protrusion, wherein the puck includes a recessed portion sized to receive the second mounting portion protrusion, and wherein the second mounting portion is permitted to rotate relative to the puck when the second mounting portion protrusion is inserted into the recessed portion.

9. The mounting system of claim 1, further comprising a wing extension plate configured to couple to the first mounting portion, wherein the first mounting portion has a third opening in the first mounting portion that is located at a first distance relative to the center of the first mounting portion, wherein the wing extension has a fourth opening, wherein the fourth opening is at a second distance when the wing extension play is coupled to the first mounting portion, wherein the second distance is greater than the first distance.

10. The mounting system of claim 9, wherein the fourth opening comprises a variable attachment opening.

11. A device mount, comprising:
a first mounting portion configured to operatively connect to a device, the first mounting portion having a variable attachment opening and a curved portion, wherein the curved portion has an outer surface, wherein the curved portion has a slot formed through the curved portion;
a second mounting portion configured to couple to a mounting surface, wherein the second mounting portion has a first opening;
a puck disposed between the first mounting portion and the second mounting portion, the puck including:
a curved inner surface, wherein the curved inner surface complements the outer surface of the curved portion of the first mounting portion, and
a second opening;
a retaining member; and
a coupling member configured to insert through the slot, the first opening, and the second opening, and couple to the retaining member, wherein the coupling member and the retaining member cooperatively couple together the first mounting portion, the puck, and the second mounting portion;
wherein the first mounting portion is pivotable relative to the second mounting portion.

12. The device mount of claim 10, wherein the variable attachment opening is configured to couple to a first fastener having a first body and a second fastener having a second body, wherein the first body is larger than the second body.

13. The device mount of claim 11, wherein the variable attachment opening is further configured to couple to the first fastener when the first fastener is coupled to the device.

14. The device mount of claim 10, wherein the curved portion has an inner surface, wherein the retaining member has a rear surface, wherein the rear surface has a curvature that complements a curvature of the inner surface of the curved portion.

15. The device mount of claim 13, wherein the retaining member has a protrusion extending from the rear surface, at least a portion of the protrusion configured to extend through the slot formed through the curved portion of the first mounting portion, and wherein protrusion is sized to substantially prevent movement of the retaining member relative to the curved portion of the first mounting portion.

16. The device mount of claim 10, wherein the retaining member moveably engages the puck through the slot of the curved portion of the first mounting portion.

17. The device mount of claim 10, wherein the second mounting portion further includes a second mounting portion protrusion, wherein the puck includes a recessed portion opposite the curved inner surface, wherein the recessed portion is sized to receive the second mounting portion protrusion, and wherein the second mounting portion is permitted to rotate relative to the puck when the second mounting portion protrusion is inserted into the recessed portion.

18. The mounting system of claim 1, further comprising a wing extension plate configured to couple to the first mounting portion, wherein the first mounting portion has a third opening in the first mounting portion that is located at a first distance relative to the center of the first mounting portion, wherein the wing extension has a variable attachment opening, wherein the variable attachment opening is at a second distance when the wing extension play is coupled to the first mounting portion, wherein the second distance is greater than the first distance.

19. A device mount, comprising:
a first mounting portion configured to operatively connect to a device, the first mounting portion having a first curved portion and a second curved portion, wherein the first curved portion has a first outer surface, wherein the second curved portion has a second outer surface, wherein the first curved portion has a first slot formed through the first curved portion, wherein the second curved portion has a second slot formed through the second curved portion;
a second mounting portion configured to couple to a mounting surface, wherein the second mounting portion has a first opening and a curved slot;
a first puck disposed between the first mounting portion and the second mounting portion, the first puck including:
a first curved inner surface, wherein the first curved inner surface complements the first outer surface of the first curved portion of the first mounting portion, and a second opening;
a second puck disposed between the first mounting portion and the second mounting portion, the second puck including:
a second curved inner surface, wherein the second curved inner surface complements the second outer surface of the second curved portion of the first mounting portion, and
a third opening;
a first retaining member;
a second retaining member;
a first coupling member configured couple to the first retaining member and to insert through the first opening, the second opening, and the first slot, wherein the first coupling member and the first retaining member cooperatively couple together the first mounting portion, the first puck, and the second mounting portion; and
a second coupling member configured couple to the second retaining member and to insert through the curved slot, the third opening, and the second slot, and wherein the second coupling member and the second retaining member cooperatively couple together the first mounting portion, the second puck, and the second mounting portion,
wherein the first mounting portion is pivotable relative to the second mounting portion.

20. The device mounting plate of claim 19, wherein the second coupling member is configured to slidably move within the curved slot, and wherein the first mounting portion is rotatable relative to the second mounting portion about and axis defined by the first coupling member.
